(19) United States
(12) Patent Application Publication
(10) Pub. No.: US 2025/0258471 A1
(43) Pub. Date: Aug. 14, 2025

(54) APPARATUS, CONTROL DEVICE, METHOD, AND COMPUTER PROGRAM FOR MANAGING TEMPERATURE OF AN IMAGING UNIT

(71) Applicant: FANUC CORPORATION, Yamanashi (JP)

(72) Inventor: Yuusuke Oota, Yamanashi (JP)

(21) Appl. No.: 19/192,629

(22) Filed: Apr. 29, 2025

Related U.S. Application Data
(63) Continuation of application No. PCT/JP2022/041368, filed on Nov. 7, 2022.

(51) Int. Cl. G05B 19/042; H04N 23/52

(52) U.S. Cl. CPC G05B 19/0425; H04N 23/52

(57) ABSTRACT

An apparatus including a temperature acquisition unit that acquires a temperature measured by a temperature sensor; a temperature determination unit that determines whether the temperature acquired by the temperature acquisition unit at the time of executing the detection operation for work is within an allowable range determined in advance in order to ensure the accuracy of the detection operation; and a temperature regulation unit that executes a warm-up operation for raising the temperature when the temperature determination unit determines that the temperature is lower than the lower limit of the allowable range, and executes a cooling operation for lowering the temperature when the temperature determination unit determines that the temperature is higher than the upper limit of the allowable range.

### CROSS-REFERENCE TO RELATED APPLICATIONS

This application is a bypass continuation application of International Application No. PCT/JP2022/041368 filed Nov. 7, 2022.

### BACKGROUND

### Field

The present disclosure relates to an apparatus, a controller, a method, and a computer program configured to manage a temperature of an imaging unit of an industrial machine.

### Discussion of the Related Art

There is known a technique for adjusting an interval at which an imaging device executes an imaging operation in response to a temperature of the imaging device.

In an industrial machine configured to execute a detection operation for detecting a workpiece on the basis of image data obtained by imaging the workpiece by an imaging unit, there has been a problem that the accuracy of the detection operation is affected by the temperature of the imaging unit.

### SUMMARY

According to an aspect of the present disclosure, in an industrial machine which executes a detection operation to detect a workpiece on the basis of image data of the workpiece imaged by an imaging unit and which carries out work on the detected workpiece, an apparatus configured to manage a temperature of the imaging unit includes: a temperature acquisition unit configured to acquire a temperature measured by a temperature sensor; a temperature determination unit configured to determine whether or not the temperature, which is acquired by the temperature acquisition unit when the detection operation for the work is executed, falls within an allowable range predetermined for securing accuracy of the detection operation; and a temperature adjustment unit configured to execute a warming-up operation to raise the temperature when the temperature determination unit determines that the temperature is lower than a lower limit value of the allowable range, while executing a cooling operation to lower the temperature when the temperature determination unit determines that the temperature is higher than an upper limit value of the allowable range.

### BRIEF DESCRIPTION OF THE DRAWINGS

FIG. 1 is a schematic diagram of an industrial machine according to an embodiment.

FIG. 2 is a block diagram of the industrial machine illustrated in FIG. 1.

FIG. 3 is an enlarged diagram of an imaging unit illustrated in FIG. 1.

FIG. 4 is a flowchart illustrating an example of an operation flow of the industrial machine illustrated in FIG. 1.

FIG. 5 illustrates an example of image data of a workpiece imaged by an imaging unit.

FIG. 6 is a flowchart illustrating another example of the operation flow of the industrial machine illustrated in FIG. 1.

FIG. 7 is a flowchart illustrating an example of a flow of step S10 in FIG. 6.

FIG. 8 is a block diagram illustrating another function of the industrial machine illustrated in FIG. 1.

FIG. 9 is a flowchart illustrating an example of an operation flow of an industrial machine illustrated in FIG. 8.

FIG. 10 is a block diagram illustrating another function of the industrial machine illustrated in FIG. 1.

FIG. 11 is a flowchart illustrating an example of an operation flow of an industrial machine illustrated in FIG. 10.

FIG. 12 illustrates an example of a result list image.

FIG. 13 illustrates an example of a result detail image.

FIG. 14 illustrates an example of a result comparison image.

FIG. 15 is a block diagram illustrating still another function of the industrial machine illustrated in FIG. 1.

FIG. 16 is a flowchart illustrating an example of an operation flow of an industrial machine illustrated in FIG. 15.

FIG. 17 is a block diagram illustrating yet another function of the industrial machine illustrated in FIG. 1.

FIG. 18 is a flowchart illustrating an example of a warming-up scheme executed by an industrial machine illustrated in FIG. 17.

FIG. 19 is a flowchart illustrating another example of the warming-up scheme executed by the industrial machine illustrated in FIG. 17.

### DETAILED DESCRIPTION OF THE EMBODIMENTS

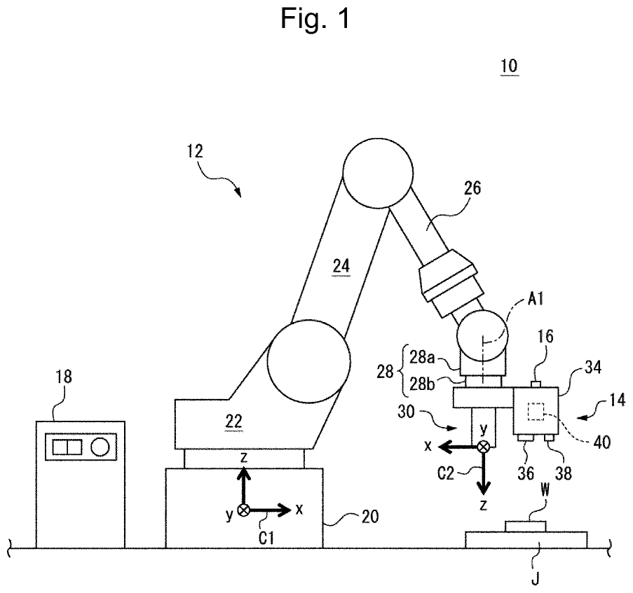

Embodiments of the present disclosure are described in detail below with reference to the drawings. Note that in various embodiments described below, the same elements are denoted with the same reference numerals, and overlapping description is omitted. Referring first to FIGS. 1 to 3, an industrial machine 10 according to an embodiment will be described. The industrial machine 10 includes a robot 12, an imaging unit 14, a temperature sensor 16, and a controller 18.

In the present embodiment, the robot 12 is a vertical articulated robot, which includes a robot base 20, a swivel body 22, a lower arm 24, an upper arm 26, a wrist 28, and an end effector 30. The robot base 20 is fixed on the floor of a work cell or on an automatically guided vehicle (AGV). The swivel body 22 is mounted on the robot base 20 to be rotatable around a vertical axis. A proximal end part of the lower arm 24 is provided to the swivel body 22 to be rotatable about a horizontal axis, and a proximal end part of the upper arm 26 is rotatably provided to a distal end part of the lower arm 24.

The wrist 28 includes a wrist base 28a provided at a distal end part of the upper arm 26 to be rotatable about two axes orthogonal to each other, and a wrist flange 28b provided to the wrist base 28a to be rotatable about a wrist axis A1. The end effector 30 is detachably attached to the wrist flange 28b. The end effector 30 includes, for example, a robot hand, a cutting tool, a laser process head, or a welding torch, and carries out predetermined work (such as workpiece handling, cutting, laser processing, or welding) on a workpiece W.

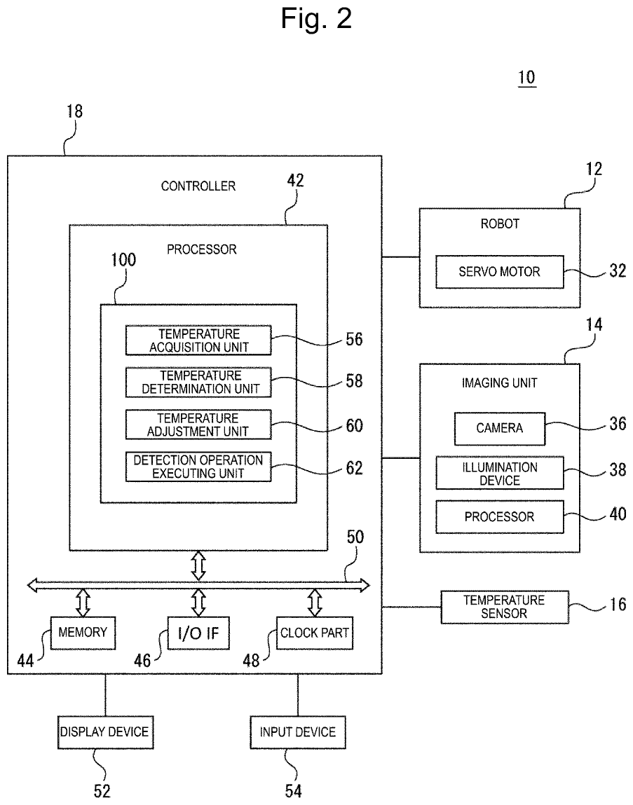

The robot base 20, the swivel body 22, the lower arm 24, the upper arm 26, and the wrist 28 are respectively provided with a plurality of servo motors 32 (FIG. 2). In response to a command from the controller 18, the servo motors 32 rotate each of the swivel body 22, the lower arm 24, the upper arm 26, the wrist base 28a, and the wrist flange 28b about drive shafts, thereby moving the end effector 30.

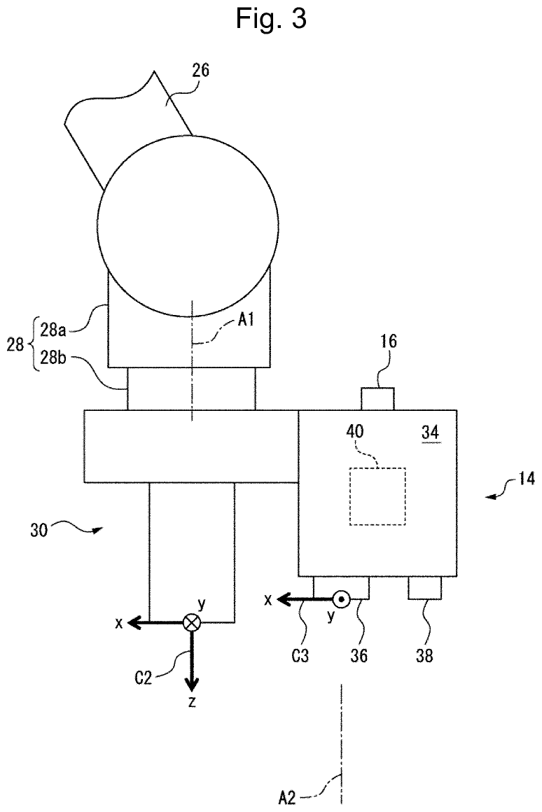

The imaging unit 14 images the workpiece W in response to a command from the controller 18. In the present embodiment, the imaging unit 14 is fixed to the end effector 30 (or the wrist flange 28b) and moved by the robot 12. Specifically, as illustrated in FIG. 3, the imaging unit 14 includes a housing 34, a camera 36, an illumination device 38, and a processor 40. The housing 34 is hollow and accommodates therein electronic components such as the processor 40.

The camera 36 of the present embodiment is a two-dimensional camera capable of imaging two-dimensional image data, and is provided in the housing 34. To be specific, the camera 36 includes an image sensor (CCD, CMOS, or the like), an optical lens (collimator lens, focus lens, or the like) that guides a subject image to the image sensor, a shutter that opens/closes an optical path of the subject image to be incident on the image sensor, and the like, and images the subject image (i.e., the workpiece W) along an optical axis A2.

The illumination device 38 includes an LED illumination, a halogen lamp, a fluorescent lamp, or the like, and is provided in the housing 34 to be adjacent to the camera 36. When the camera 36 images the workpiece W, the illumination device 38 irradiates the workpiece W with light in response to a command from the controller 18. As described above, in the present embodiment, the camera 36 and the illumination device 38 are integrally incorporated in the housing 34. The processor 40 includes, for example, an image processing processor (DSP, ISP, or the like) configured to perform image processing on image data imaged by the camera 36, and supplies the acquired image data to the controller 18.

The temperature sensor 16 includes a platinum temperature measuring resistor, a thermocouple, or the like, and measures a temperature T of the imaging unit 14. In the present embodiment, the temperature sensor 16 is provided in the housing 34. However, the temperature sensor 16 may be disposed on any component of the imaging unit 14, such as the camera 36 (specifically, the image sensor or the optical lens), the illumination device 38, or the processor 40. The temperature sensor 16 supplies data of the measured temperature T to the controller 18.

Referring to FIG. 2, the controller 18 controls the operations of the robot 12 and the imaging unit 14. Specifically, the controller 18 is a computer including a processor 42, a memory 44, an I/O interface 46, and a clock part 48. The processor 42 includes a CPU, a GPU, or the like, is communicably connected to the memory 44, the I/O interface 46, and the clock part 48 via a bus 50, and performs arithmetic processing to enable a temperature management function described later while communicating with these components.

The memory 44 includes a RAM, a ROM, or the like and temporarily or permanently stores various types of data. The memory 44 may be a non-transitory computer readable recording medium such as a semiconductor memory, a magnetic recording medium, or an optical recording medium. The I/O interface 46 includes, for example, an Ethernet (registered trademark) port, a USB port, an optical fiber connector, or an HDMI (registered trademark) terminal, and communicates data with the external device in a wired or wireless manner under a command from the processor 42. In the present embodiment, the imaging unit 14, the temperature sensor 16, and each of the servo motors 32 are communicably connected to the I/O interface 46. In response to a command from the processor 42, the clock part 48 clocks an elapsed time t from a certain time point.

The controller 18 is provided with a display device 52 and an input device 54. The display device 52 includes a liquid crystal display, an organic EL display, or the like, and visibly displays various types of data under a command from the processor 42. The input device 54 includes a push button, a switch, a keyboard, a mouse, a touch panel, or the like, and receives an input of data from an operator. The display device 52 and the input device 54 may be integrally incorporated in a housing of the controller 18, or may be constituted as one computer (such as a PC) with a body separate from the housing of the controller 18, and may be connected to the I/O interface 46.

As illustrated in FIG. 1, a robot coordinate system (or a world coordinate system) C1 and a tool coordinate system C2 are set for the robot 12. The robot coordinate system C1 is a coordinate system for controlling the operations of movable components (i.e., the swivel body 22, the lower arm 24, the upper arm 26, and the wrist 28) of the robot 12. In the present embodiment, the robot coordinate system C1 is set for the robot base 20 such that the origin is arranged at the center of the robot base 20 and the z axis coincides with a swivel shaft of the swivel body 22.

On the other hand, the tool coordinate system C2 is set for the end effector 30 and determines the position of the end effector 30 in the robot coordinate system C1. In the present embodiment, the tool coordinate system C2 is set for the end effector 30 such that the origin (i.e., the TCP) is arranged at a work position (e.g., a workpiece gripping position, a tool distal end point, a laser beam exit port, or a welding position) of the end effector 30 and the z axis is parallel to (specifically, coincides with) a wrist axis A1.

When moving the end effector 30, the processor 42 of the controller 18 sets the tool coordinate system C2 in the robot coordinate system C1, and generates a command for each of the servo motors 32 of the robot 12 so as to arrange the end effector 30 at a position represented by the set tool coordinate system C2. In this way, the end effector 30 is positioned at an optional position in the robot coordinate system C1 by the operation of the robot 12.

On the other hand, a camera coordinate system C3 is set for the camera 36 of the imaging unit 14 as illustrated in FIG. 3. The camera coordinate system C3 determines the position of the camera 36 in the robot coordinate system C1 (i.e., the coordinates of the optical axis A2) and also determines the coordinates of each pixel of the image data (or the image sensor) imaged by the camera 36. In the present embodiment, the camera coordinate system C3 is two-dimensional and is set for the camera 36 such that the origin is arranged at the center of the image sensor of the camera 36.

In the industrial machine 10, the processor 42 of the controller 18 operates the imaging unit 14 to image the workpiece W, and executes a detection operation DO to detect the workpiece W on the basis of image data ID of the imaged workpiece W. Then, the processor 42 operates the robot 12 to carry out work (workpiece handling, cutting, laser processing, welding, or the like) on the workpiece W detected by the detection operation DO.

As the imaging unit 14 is operated for the work, the temperature T of the imaging unit 14 fluctuates. Such a fluctuation in the temperature T affects image quality of the image data ID imaged by the imaging unit 14. Specifically, for example, when the temperature T rises, distortion occurs in the image sensor or optical lens of the camera 36, or the light amount of the illumination device 38 changes (e.g., increases). As a result, distortion of the imaged image data ID or brightness of the pixel may change.

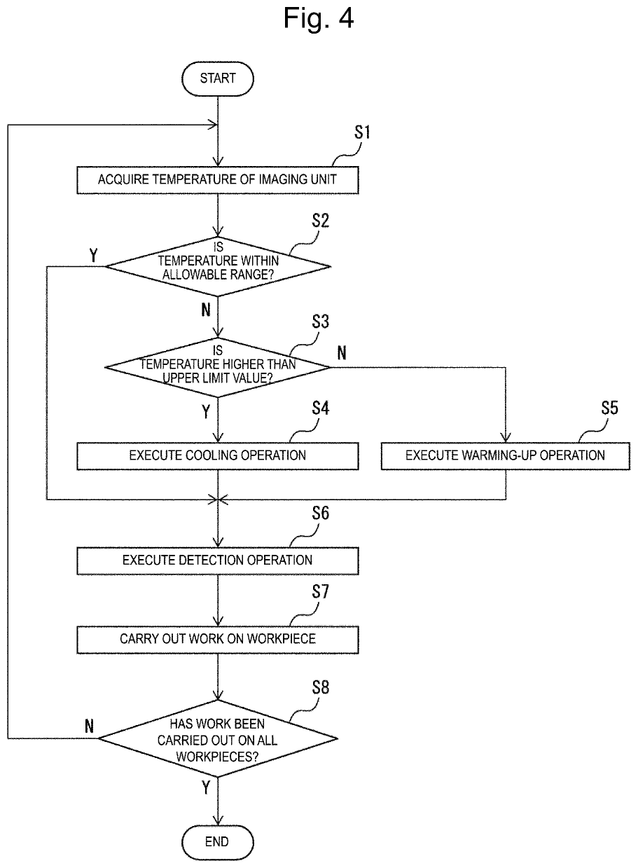

When the image quality of the image data ID is affected as described above, the accuracy of the detection operation DO executed on the basis of the image data ID may be lowered. Accordingly, in the present embodiment, the processor 42 manages the temperature T of the imaging unit 14 in order to secure the accuracy of the detection operation DO when carrying out work on the workpiece W. Hereinafter, an operation flow of the industrial machine 10 will be described with reference to FIG. 4.

The flow illustrated in FIG. 4 starts when the processor 42 receives a work start command from an operator, a host controller, or a computer program PG. In step S1, the processor 42 acquires the temperature T of the imaging unit 14. Specifically, the processor 42 acquires data of the temperature T measured by the temperature sensor 16 at this time point, from the temperature sensor 16. In this manner, in the present embodiment, the processor 42 functions as a temperature acquisition unit 56 (FIG. 2) configured to acquire the temperature T measured by the temperature sensor 16.

In step S2, the processor 42 determines whether or not the temperature T acquired in the most recent step S1 falls within an allowable range [Tₜₕ₁, Tₜₕ₂]. The allowable range [Tₜₕ₁, Tₜₕ₂] is predetermined in order to secure the accuracy of the detection operation DO executed in step S6 described below. A method of determining the allowable range [Tₜₕ₁, Tₜₕ₂] will be described later. Data of a lower limit value Tₜₕ₁ and an upper limit value Tₜₕ₂ defining the allowable range [Tₜₕ₁, Tₜₕ₂] is stored in advance in the memory 44.

When the temperature T falls within the allowable range [Tₜₕ₁, Tₜₕ₂] (i.e., Tₜₕ₁≤T≤Tₜₕ₂), the processor 42 determines YES, and proceeds to step S6. On the other hand, when the temperature T is outside the allowable range [Tₜₕ₁, Tₜₕ₂] (i.e., T<Tₜₕ₁ or Tₜₕ₂<T), the processor 42 determines NO, and proceeds to step S3. As discussed above, in the present embodiment, the processor 42 functions as a temperature determination unit 58 (FIG. 2) configured to determine whether or not the temperature T falls within the allowable range [Tₜₕ₁, Tₜₕ₂].

In step S3, the processor 42 functions as the temperature determination unit 58 and determines whether or not the temperature T acquired in the most recent step S1 is higher than the upper limit value Tₜₕ₂ of the allowable range [Tₜₕ₁, Tₜₕ₂] or lower than the lower limit value Tₜₕ₁ of the allowable range [Tₜₕ₁, Tₜₕ₂]. The processor 42 determines YES when the temperature T is higher than the upper limit value Tₜₕ₂ (i.e., Tₜₕ₂<T), and proceeds to step S4. On the other hand, the processor 42 determines NO when the temperature T is lower than the lower limit value Tₜₕ₁ (i.e., T<Tₜₕ₁), and proceeds to step S5.

In step S4, the processor 42 executes a cooling operation CO to lower the temperature T of the imaging unit 14. Specifically, the processor 42 activates the clock part 48 to start the clocking of an elapsed time t1 from the start time point of step S4. The processor 42 may activate the clock part 48 at the start time point or the end time point of step S1 mentioned above to clock the elapsed time t1 from the start time point or the end time point thereof.

Then, when the elapsed time t1 clocked by the clock part 48 reaches a predetermined cooling time tₜₕ₁, the processor 42 ends step S4. As an example, the cooling time tₜₕ₁ may be predetermined by an operator as a required value. As another example, the processor 42 may determine the cooling time tₜₕ₁ in response to the temperature T of the imaging unit 14. For example, a data table DT1 (or a graph) is stored in advance in the memory 44. In the data table DT1, the temperature T of the imaging unit 14 and the cooling time tₜₕ₁ required to lower the temperature T to the upper limit value Tₜₕ₂ or less are stored in association with each other. The data table DT1 is generated in advance by an experimental method or simulation carried out by the operator, for example.

When the processor 42 starts step S4 (or determined YES in step S3), the processor 42 may determine the cooling time tₜₕ₁ corresponding to the temperature T by applying the temperature T acquired in the most recent step S1 to the data table DT1. Thus, the processor 42 can determine the cooling time tₜₕ₁ to be referred to in step S4 in response to the temperature T. The processor 42 can also determine the cooling time tₜₕ₁ in response to the temperature T by executing a predetermined calculation using the temperature T and a heat dissipation parameter of the imaging unit 14 (e.g., thermal conductivity of the housing 34).

Until the elapsed time t1 clocked by the clock part 48 reaches the cooling time tₜₕ₁, the processor 42 stops the operations of the components of the imaging unit 14 (i.e., the camera 36, the illumination device 38, and the processor 40). As an example, the processor 42 stops the operation of each component (e.g., the processor 40) of the imaging unit 14 by stopping the command toward the component.

At this time, the processor 42 may continue to provide minimal power to at least one component of imaging unit 14. This configuration makes it possible to suppress power consumption in the imaging unit 14, whereby the temperature T of the imaging unit 14 can be lowered, and various setting information temporarily stored in a memory (not illustrated) of the imaging unit 14 can be maintained.

As another example, the processor 42 may stop the operation of each component of the imaging unit 14 by stopping the power supply to the component. Thus, the processor 42 can lower the temperature T of the imaging unit 14 by stopping the operation of the imaging unit 14 for the predetermined cooling time tₜₕ₁.

Referring to FIG. 4 again, in a case where the determination made in step S3 is NO, the processor 42 executes a warming-up operation WO to raise the temperature T of the imaging unit 14 in step S5. As an example of the warming-up operation WO, the processor 42 causes the camera 36 to simulatively execute an imaging operation IO. In the imaging operation IO, the camera 36 may image the workpiece W or may image any subject other than the workpiece W. Alternatively, the camera 36 may execute the imaging operation IO in a state where the shutter is closed. In this case, a subject image of the shutter (i.e., a black image) is captured by the image sensor.

In the imaging operation IO, the camera 36 may repeatedly execute imaging of the subject image a predetermined number of times, or may continuously image the subject image for a predetermined time (i.e., moving image capturing). Imaging conditions CDi (exposure time, shutter speed, resolution, sensitivity, and the like) when the imaging operation IO is executed may be completely identical to the imaging conditions CDi when the workpiece W is imaged in step S6 described later, or may be at least partially different therefrom.

As another example of the warming-up operation WO, the processor 42 causes the processor 40 incorporated in the imaging unit 14 to execute predetermined arithmetic processing CL. For example, the processor 40 executes image processing CL1, as the arithmetic processing CL, on the image data ID of the workpiece W imaged in step S6 (FIG. 4) executed before step S5.

As the image processing CL1, the processor 40 executes, for example, processing of obtaining an edge or a contour of the workpiece W appearing in the image data ID, or processing of eliminating noise from the image data ID. As described above, by executing the image processing CL1 on the image data ID accumulated in the past while making use of the warming-up operation WO, the cycle time of the flow in FIG. 4 can be reduced.

The processor 40 may execute any processing other than the image processing CL1 (or in addition to the image processing CL1), as the arithmetic processing CL. As discussed above, the processor 42 of the controller 18 causes the processor 40 of the imaging unit 14 to execute the arithmetic processing CL so as to operate the processor 40, thereby making it possible for the processor 40 to generate heat. As a result, the temperature T of the imaging unit 14 can be raised.

As still another example of the warming-up operation WO, the processor 42 executes a lighting operation LO to turn on the illumination device 38. As a result, the illumination device 38 generates heat, whereby the temperature T of the imaging unit 14 can be raised. Lighting conditions CDI (power, illuminance, frequency, and the like) when the lighting operation LO is executed may be completely identical to the lighting conditions CDI when the lighting operation LO is executed in step S6 described later, or may be at least partially different therefrom. For example, at least one of the lighting conditions CDI (e.g., power or illuminance) in the warming-up operation WO may be set to be larger than that in step S6.

The processor 40 may execute the warming-up operation WO in step S5 (i.e., the simulative imaging operation IO, the arithmetic processing CL, or the lighting operation LO) for a predetermined warming-up time tₜₕ₂. Specifically, the processor 42 activates the clock part 48 to start the clocking of a third elapsed time t3 from the start time point of step S5. The processor 42 may activate the clock part 48 at the start time point or the end time point of the above-mentioned step S1 to clock the elapsed time t3 from the start time point or the end time point thereof.

Then, when the elapsed time t3 clocked by the clock part 48 reaches the predetermined warming-up time tₜₕ₂, the processor 42 ends step S5. As an example, the warming-up time tₜₕ₂ may be predetermined by the operator as a required value. As another example, the processor 42 may determine the warming-up time tₜₕ₂ in response to the temperature T of the imaging unit 14. For example, a data table DT2 (or a graph) is stored in advance in the memory 44. In the data table DT2, the temperature T of the imaging unit 14 and the warming-up time tₜₕ₂ required to raise the temperature T to the lower limit value Tₜₕ₁ or more are stored in association with each other.

The data table DT2 is generated in advance by an experimental method or simulation carried out by the operator, for example. When the processor 42 starts step S5 (or determined NO in step S3), the processor 42 may determine the warming-up time tₜₕ₂ corresponding to the temperature T by applying the temperature T acquired in the most recent step S1 to the data table DT2.

As described above, in the present embodiment, when it is determined as a result of steps S2 and S3 that the temperature T is higher than the upper limit value Tₜₕ₂ of the allowable range [Tₜₕ₁, Tₜₕ₂], the processor 42 executes the cooling operation CO to lower the temperature T in step S4. On the other hand, when it is determined that the temperature T is lower than the lower limit value Tₜₕ₁ of the allowable range [Tₜₕ₁, Tₜₕ₂], the processor 42 executes the warming-up operation WO to raise the temperature T in step S5. Thus, the processor 42 functions as a temperature adjustment unit 60 (FIG. 2) configured to execute the cooling operation CO and the warming-up operation WO.

In step S6, the processor 42 executes the detection operation DO configured to detect the workpiece W. To be specific, the processor 42 operates the robot 12 to arrange the imaging unit 14 at an imaging position IP1, at which the workpiece W set on a jig J falls within the field of view of the camera 36. Subsequently, the processor 42 causes the illumination device 38 to execute the lighting operation LO to irradiate the workpiece W with light.

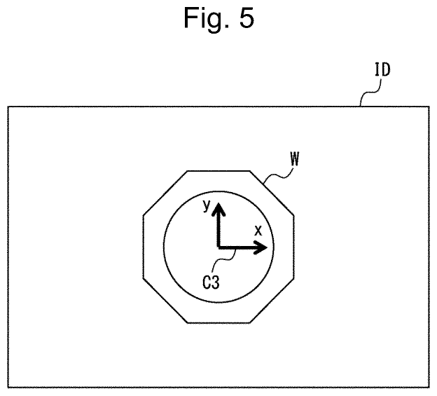

While the illumination device 38 is executing the lighting operation LO, the camera 36 is activated to execute the imaging operation IO for imaging the workpiece W. The processor 42 acquires the image data ID imaged by the imaging operation IO from the camera 36. An example of the image data ID acquired at this time is illustrated in FIG. 5. Each pixel of the image data ID is represented as coordinates in the camera coordinate system C3.

Subsequently, the processor 42 detects the workpiece W appearing in the image data ID by matching a teaching shape TS taught in advance of the workpiece W with the image data ID. Then, the processor 42 acquires coordinates Qc in the camera coordinate system C3 of a feature point (e.g., a center point) of the workpiece W in the detected image data ID.

Here, the positional relationship between the camera coordinate system C3 and the robot coordinate system C1 (i.e., the tool coordinate system C2) is known by a calibration process CB described later. Thus, the coordinates of the camera coordinate system C3 and the coordinates of the robot coordinate system C1 can be transformed to each other through a known transformation matrix M_{cr} (e.g., homogeneous transformation matrix or Jacobian matrix).

On the other hand, in the present embodiment, a distance d between the camera 36 arranged at the imaging position IP1 (i.e., the origin of the camera coordinate system C3) and the workpiece W set on the jig J is also known. The processor 42 acquires a position P (x, y, z) of the workpiece W in the robot coordinate system C1 on the basis of the acquired coordinates Qc in the camera coordinate system C3, the distance d, and the transformation matrix M_{cr}. Thus, the processor 42 executes the detection operation DO to detect the workpiece W on the basis of the image data ID, and acquires the position P of the workpiece W in the robot coordinate system C1 as a detecting position P (x, y, z). Accordingly, the processor 42 functions as a detection operation executing unit 62 (FIG. 2) configured to execute the detection operation DO.

In step S7, the processor 42 executes work on the workpiece W. To be specific, on the basis of the detecting position P acquired in the most recent step S6 and a teaching position P0 taught in advance, the processor 42 calculates a deviation amount δP from the teaching position P0 to the detecting position P. The teaching position P0 is taught in advance together with the above-described teaching shape TS in a teaching process TP to be described later, and is determined in the computer program PG for the flow of FIG. 4.

Then, the processor 42 corrects a command (e.g., a position command) toward each servo motor 32 for positioning the end effector 30 (i.e., the TCP) to the teaching position P0, which is determined in the computer program PG on the basis of the calculated deviation amount OP, and drives each servo motor 32 in accordance with the corrected command. With this, the processor 42 moves the end effector 30 by the operation of the robot 12, and carries out work (workpiece handling, cutting, laser processing, welding, or the like) on the workpiece W arranged at the detecting position P by the end effector 30.

In step S8, the processor 42 determines whether or not the work has been carried out on all the workpieces W. The processor 42 ends the flow illustrated in FIG. 4 upon determining YES, or returns to step S1 upon determining NO. In this manner, the processor 42 repeatedly executes a loop of step S1 to step S8 until determining YES in step S8.

As described above, in the present embodiment, the industrial machine 10 (to be specific, the processor 42 of the controller 18) executes the detection operation DO for detecting the workpiece W on the basis of the image data ID obtained by imaging the workpiece W by the imaging unit 14 (step S6), and carries out work on the detected workpiece W (step S7). In this type of industrial machine 10, the processor 42 functions as the temperature acquisition unit 56, the temperature determination unit 58, the temperature adjustment unit 60, and the detection operation executing unit 62, and manages the temperature T of the imaging unit 14. Accordingly, the temperature acquisition unit 56, the temperature determination unit 58, the temperature adjustment unit 60, and the detection operation executing unit 62 constitute an apparatus 100 (FIG. 2) configured to manage the temperature T of the imaging unit 14.

In the apparatus 100, the temperature determination unit 58 determines whether or not the temperature T, which is acquired by the temperature acquisition unit 56 when the detection operation DO (step S6) for the work (step S7) is executed, falls within the allowable range [Tₜₕ₁, Tₜₕ₂] predetermined to secure the accuracy of the detection operation DO (step S2). When the temperature determination unit 58 determines that the temperature T is lower than the lower limit value Tₜₕ₁ of the allowable range [Tₜₕ₁, Tₜₕ₂] (i.e., NO in step S3), the temperature adjustment unit 60 executes the warming-up operation WO for raising the temperature T (step S5).

On the other hand, when the temperature determination unit 58 determines that the temperature T is higher than the upper limit value Tₜₕ₂ of the allowable range [Tₜₕ₁, Tₜₕ₂] (i.e., YES in step S3), the temperature adjustment unit 60 executes the cooling operation CO for lowering the temperature T (step S4). This configuration makes it possible to manage the temperature T of the imaging unit 14 when the detection operation DO is executed so that the temperature T is brought close to the allowable range [Tₜₕ₁, Tₜₕ₂], in which the accuracy of the detection operation DO can be secured. Accordingly, the accuracy of the detection operation DO can effectively be secured.

In addition, in the apparatus 100, the temperature adjustment unit 60 causes the imaging unit 14 to simulatively execute the imaging operation IO as an example of the warming-up operation WO. According to this configuration, it is possible to easily raise the temperature T of the imaging unit 14 without separately providing a heating device (e.g., a heater). As another example of the warming-up operation WO, the temperature adjustment unit 60 causes the processor 40 incorporated in the imaging unit 14 to execute the predetermined arithmetic processing CL.

In a case where the processor 40 is caused to execute the above-described image processing CL1 as the arithmetic processing CL, the temperature T can be raised without using a heating device, and the cycle time of the work can be reduced. As still another example of the warming-up operation WO, the temperature adjustment unit 60 turns on the illumination device 38 provided in the imaging unit 14. This configuration makes it possible to easily and reliably raise the temperature T of the imaging unit 14 without using a heating device.

Further, in the apparatus 100, the temperature adjustment unit 60 lowers the temperature T by stopping the operation of the imaging unit 14 for the predetermined cooling time tₜₕ₁ as the cooling operation CO. This configuration makes it possible to easily and reliably lower the temperature T of the imaging unit 14 without separately providing a cooling device (e.g., a cooling fan).

In step S5 described above, the processor 42 may execute at least two (e.g., all) of the simulative imaging operation IO, the arithmetic processing CL, and the lighting operation LO of the illumination device 38 in parallel as the warming-up operation WO. A heating device (a heater or the like) may be further provided in the imaging unit 14, and the processor 42 may operate the heating device as the warming-up operation WO in step S5 to raise the temperature T of the imaging unit 14 by the heating device. The imaging unit 14 may be further provided with a cooling device (a cooling fan or the like), and the processor 42 may operate the cooling device as the cooling operation CO in step S4 described above to lower the temperature T of the imaging unit 14 by the cooling device.

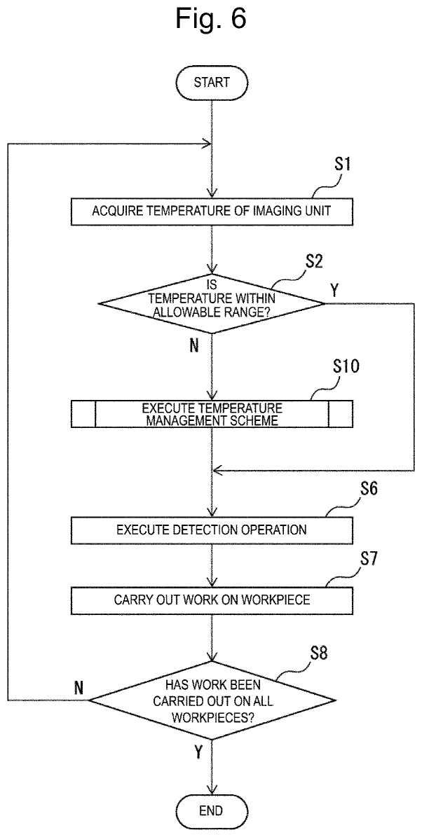

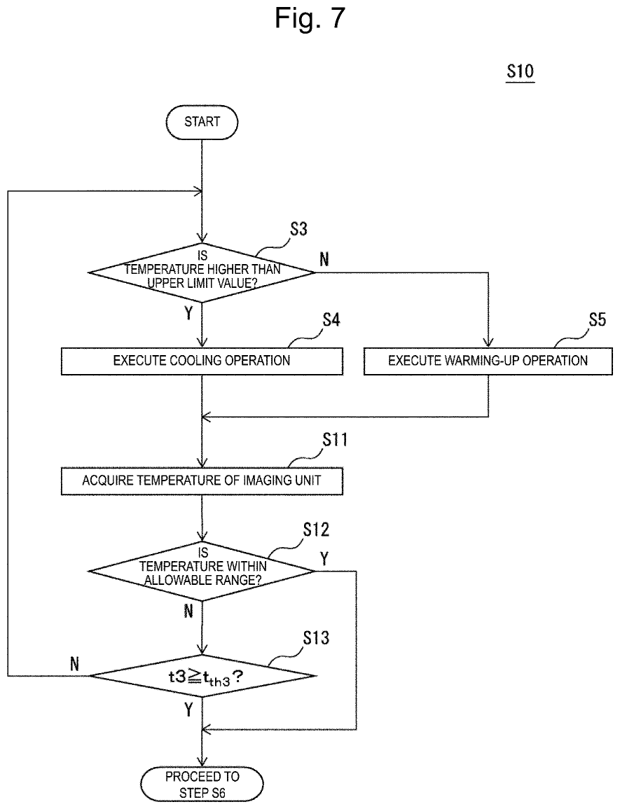

Next, another example of the operation flow of the industrial machine 10 will be described with reference to FIGS. 6 and 7. In the flow illustrated in FIGS. 6 and 7, the same processing as that in the flow of FIG. 4 is denoted by the same step number, and redundant description thereof will be omitted. In the present embodiment, when the processor 42 determines NO in step S2, a temperature management scheme is executed in step S10.

As illustrated in FIG. 7, after step S10 is started, the processor 42 executes the above-described steps S3 to S5 in sequence. After step S4 or S5, the processor 42 functions as the temperature acquisition unit 56 to acquire the temperature T of the imaging unit 14 in step S11, as in step S1 described above. In step S12, as in step S2 described above, the processor 42 functions as the temperature determination unit 58 to determine whether or not the temperature T acquired in the most recent step S11 falls within the allowable range [Tₜₕ₁, Tₜₕ₂]. The processor 42 proceeds to step S6 in FIG. 6 upon determining YES, or proceeds to step S13 upon determining NO.

In step S13, the processor 42 determines whether or not the third elapsed time t3 clocked by the clock part 48 has reached a predetermined time limit tₜₕ₃ (i.e., t3≥tₜₕ₃). In the present embodiment, the processor 42 activates the clock part 48 at the start time point of step S10 (i.e., the time point at which determining NO in step S2), and the clock part 48 clocks the third elapsed time t3 from this time point. The processor 42 may activate the clock part 48 at the start time point or the end time point of step S1 described above to clock the elapsed time t3 from this time point.

When the processor 42 determines that the elapsed time t3 clocked by the clock part 48 has reached the time limit tₜₕ₃ (i.e., YES), the processor 42 proceeds to step S6 in FIG. 6. On the other hand, when determining NO, the processor 42 returns to step S3. In this manner, the processor 42 repeatedly executes a loop of steps S3 to S4 and S11 to S13 in FIG. 7 until determining YES in step S12 or S13, so as to function as the temperature adjustment unit 60 to execute the cooling operation CO in step S4 or the warming-up operation WO in step S5.

As described above, in the present embodiment, the temperature determination unit 58 determines whether or not the temperature T falls within the allowable range [Tₜₕ₁, Tₜₕ₂] (step S12) each time the temperature adjustment unit 60 executes the cooling operation CO (step S4) or the warming-up operation WO (step S5). When the temperature determination unit 58 determines that the temperature T falls within the allowable range [Tₜₕ₁, Tₜₕ₂] (YES in step S12), the detection operation executing unit 62 executes the detection operation DO (step S6 in FIG. 6) for the work (step S7 in FIG. 6).

On the other hand, the detection operation executing unit 62 does not execute the detection operation DO for the work while it is determined that the temperature T is outside the allowable range [Tₜₕ₁, Tₜₕ₂] (NO in step S12). This configuration makes it possible to execute the detection operation DO in a state where the temperature T of the imaging unit 14 falls within the allowable range [Tₜₕ₁, Tₜₕ₂], thereby making it possible to more reliably secure the accuracy of the detection operation DO.

In the present embodiment, the detection operation executing unit 62 executes the detection operation DO for the work (step S6 in FIG. 6) when the elapsed time t3, which is clocked by the clock part 48 while the temperature determination unit 58 determines that the temperature T is outside the allowable range [Tₜₕ₁, Tₜₕ₂] (NO in step S12), reaches the predetermined time limit tₜₕ₃ (determined YES in step S13). Here, it is requested to prevent an excessive increase in a cycle time tc of the flow in FIG. 6. Thus, by setting the above-described time limit tₜₕ₃ in the flow of FIG. 7, an excessive increase in the cycle time tc can be prevented.

The processor 42 may determine the time limit tₜₕ₃ on the basis of the target cycle time tc. In this case, for example, the operator operates the input device 54 to input the target cycle time tc. The processor 42 automatically determines the time limit tₜₕ₃ on the basis of the input cycle time tc. With this configuration, the time limit tₜₕ₃ may be optimized.

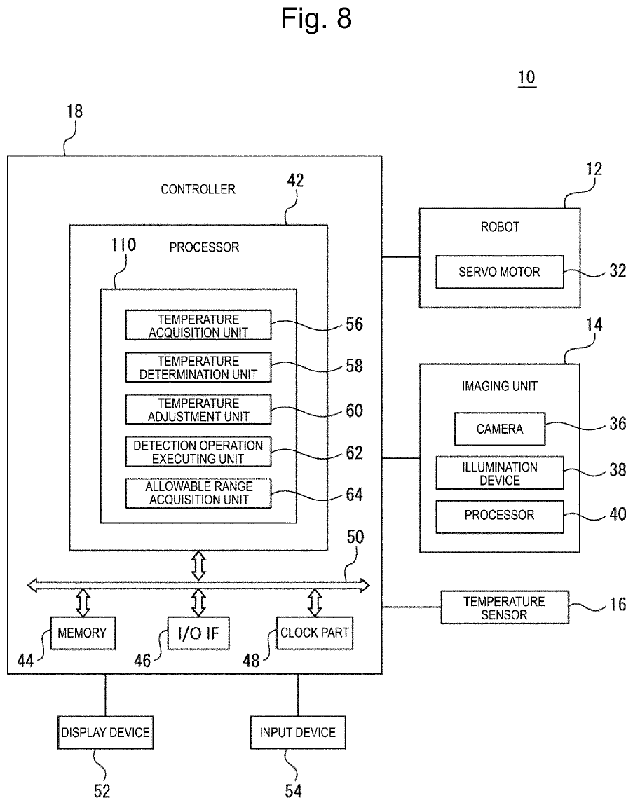

Next, a method of determining the allowable range [Tₜₕ₁, Tₜₕ₂] will be described with reference to FIGS. 1 and 8. Before executing the flow in FIG. 4 or 6, the operator executes the teaching process TP for teaching the shape TS and the teaching position P0 of the workpiece W in order to detect the workpiece W by the detection operation DO in step S6 described above. The teaching process TP will be described below. The operator may execute the teaching process TP described below using a teaching device (a teach pendant or the like). The teaching device is communicably connected to the I/O interface 46 of the controller 18.

First, the operator sets the workpiece W at the predetermined teaching position P0 using the jig J. Next, the operator gives a teaching command to the controller 18 by operating the teaching device, for example. In response to the teaching command, the processor 42 of the controller 18 operates the robot 12 to position the imaging unit 14 to the imaging position IP1.

Then, the processor 42 causes the illumination device 38 to execute the lighting operation LO to irradiate the workpiece W with light, and causes the imaging unit 14 to execute the imaging operation IO to image the workpiece W set at the teaching position P0. As a result, the image data ID is imaged as illustrated in FIG. 5. The processor 42 displays the imaged image data ID on the display device 52 (or a display device of the teaching device).

Next, while visually recognizing the image data ID displayed on the display device 52, the operator operates the input device 54 (or the input device of the teaching device) to designate a contour useful for the detection operation DO among contours of the workpiece W (an edge or a surface of the workpiece W, a boundary between the workpiece W and the background, or the like) appearing in the image data ID, and give input for masking the contours unnecessary for the detection operation DO to the controller 18. Thus, the processor 42 of the controller 18 can recognize the teaching shape TS of the workpiece W.

Subsequently, the processor 42 detects the workpiece W appearing in the image data ID by matching the taught teaching shape TS with the imaged image data ID. Then, the processor 42 acquires the position P0 of the detected workpiece W in the robot coordinate system C1 as the teaching position P0 (x0, y0, z0). By executing this type of teaching process TP, the teaching shape TS of the workpiece W and the teaching position P0 of the workpiece W are taught.

In the present embodiment, the temperature sensor 16 measures a temperature T1 (first temperature) of the imaging unit 14 when the imaging unit 14 executes the imaging operation IO for the teaching process TP. For example, the temperature sensor 16 measures the temperature T1 immediately before, immediately after, or during the execution of the imaging operation IO by the imaging unit 14 in the teaching process TP. The processor 42 functions as the temperature acquisition unit 56 and acquires the temperature T1 measured by the temperature sensors 16 in the teaching process TP.

Then, on the basis of the acquired temperature T1, the operator determines the lower limit value Tₜₕ₁ and the upper limit value Tₜₕ₂ of the allowable range [Tₜₕ₁, Tₜₕ₂]. For example, the operator sets the lower limit value Tₜₕ₁ and the upper limit value Tₜₕ₂ so as to satisfy the relation of Tₜₕ₁<T1<Tₜₕ₂. For example, the operator operates the input device 54 (or the input device of the teaching device) to input the lower limit value Tₜₕ₁ and the upper limit value Tₜₕ₂, and the processor 42 acquires the lower limit value Tₜₕ₁ and the upper limit value Tₜₕ₂ via the input device 54 and stores the acquired values in the memory 44.

Thus, the processor 42 acquires the allowable range [Tₜₕ₁, Tₜₕ₂] determined on the basis of the temperature T1. Accordingly, the processor 42 functions as an allowable range acquisition unit 64 (FIG. 8) configured to acquire the allowable range [Tₜₕ₁, Tₜₕ₂]. After acquiring the allowable range [Tₜₕ₁, Tₜₕ₂], the processor 42 executes the flow in FIG. 4 or 6, refers to the allowable range [Tₜₕ₁, Tₜₕ₂] stored in the memory 44, and executes step S2, S3, or S12.

As discussed above, in the industrial machine 10 illustrated in FIG. 8, the processor 42 functions as the temperature acquisition unit 56, the temperature determination unit 58, the temperature adjustment unit 60, the detection operation executing unit 62, and the allowable range acquisition unit 64, so as to manage the temperature T of the imaging unit 14. Accordingly, the temperature acquisition unit 56, the temperature determination unit 58, the temperature adjustment unit 60, the detection operation executing unit 62, and the allowable range acquisition unit 64 constitute an apparatus 110 configured to manage the temperature T of the imaging unit 14.

In the present embodiment, the temperature acquisition unit 56 acquires the first temperature T1 measured by the temperature sensor 16 when the imaging unit 14 executes the imaging operation IO for the teaching process TP for teaching the shape of the workpiece W. Then, the allowable range acquisition unit 64 acquires the allowable range [Tₜₕ₁, Tₜₕ₂] determined on the basis of the first temperature T1 and stores the acquired allowable range in the memory 44.

According to this configuration, it is possible to effectively determine the allowable range [Tₜₕ₁, Tₜₕ₂] so that the accuracy of the detection operation DO can be secured. To be more specific, the teaching shape TS and the teaching position P0 are taught on the basis of the image data ID imaged by the imaging operation IO executed in the teaching process TP. In a case where the temperature T of the imaging unit 14 can be brought close to the first temperature T1 measured in the imaging operation IO of the teaching process TP when step S6 is executed, the accuracy of the detection operation DO executed in step S6 mentioned above may be improved. Thus, according to the present embodiment, since the allowable range acquisition unit 64 acquires the allowable range [Tₜₕ₁, Tₜₕ₂] determined on the basis of the first temperature T1, the accuracy of the detection operation DO can be more effectively secured.

Next, another method of determining the allowable range [Tₜₕ₁, Tₜₕ₂] will be described with reference to FIGS. 1 and 8. Before executing the flow in FIG. 4 or 6, the operator executes the calibration process CB of calibrating imaging parameters PRi of the imaging unit 14. The operator may execute the calibration process CB described below using the above-described teaching device.

First, the operator sets an index DX (not illustrated) for calibration at a known position in the robot coordinate system C1. The index DX includes, for example, a dot pattern. Next, the operator gives a calibration command to the controller 18 by operating the teaching device, for example. In response to the calibration command, the processor 42 of the controller 18 operates the robot 12 to position the imaging unit 14 to an imaging position IP2, at which the index DX falls within the field of view of the camera 36.

Next, the processor 42 causes the imaging unit 14 to execute the imaging operation IO to image the index DX. As a result, image data ID′ is acquired, in which the index DX appears. Next, the processor 42 acquires respective parameters of the transformation matrix M_{cr} representing the positional relationship between the robot coordinate system C1 and the camera coordinate system C3 as the imaging parameters PRi, on the basis of the acquired image data ID′.

Further, on the basis of the image data ID′, the processor 42 acquires, as the imaging parameters PRi, correction parameters for correcting distortion of the image data ID′ caused by distortion of an optical lens of the camera 36 or the like. By executing this type of calibration process CB, the imaging parameters PRi (the parameters of the transformation matrix M_{cr}, the correction parameters, and the like) are calibrated.

In the present embodiment, the temperature sensor 16 measures a temperature T2 (first temperature) of the imaging unit 14 when the imaging unit 14 executes the imaging operation IO for the calibration process CB. For example, the temperature sensor 16 measures the temperature T2 immediately before, immediately after, or during the execution of the imaging operation IO by the imaging unit 14 in the calibration process CB. The processor 42 functions as the temperature acquisition unit 56 and acquires the temperature T2 measured by the temperature sensors 16 in the calibration process CB.

As in the teaching process TP described above, the operator determines the lower limit value Tₜₕ₁ and the upper limit value Tₜₕ₂ of the allowable range [Tₜₕ₁, Tₜₕ₂] on the basis of the acquired temperature T2. The processor 42 functions as the allowable range acquisition unit 64 to acquire the allowable range [Tₜₕ₁, Tₜₕ₂] determined on the basis of the temperature T2 and store the acquired allowable range in the memory 44. According to this configuration, the accuracy of the detection operation DO may be secured more effectively.

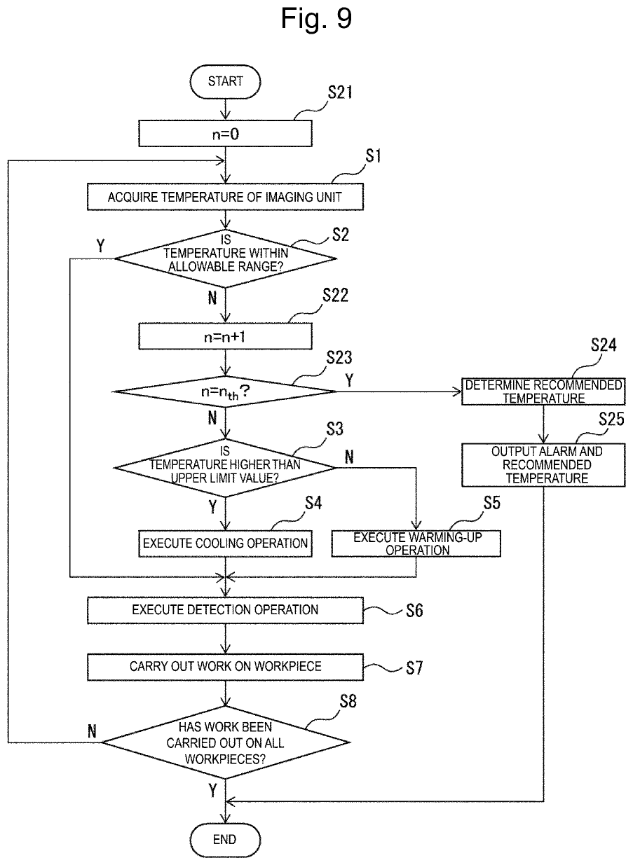

Next, an operation flow executed by the industrial machine 10 illustrated in FIG. 8 will be described with reference to FIG. 9. Note that in the flow illustrated in FIG. 9, the same processing as that in the flow of FIG. 4 is denoted by the same step number, and redundant description thereof will be omitted. The processor 42 sets a number of error times “n” to “0” in step S21. The number of error times “n” indicates the number of times of determining NO in step S2 in FIG. 9. After step S21, the processor 42 sequentially executes the above-described steps S1 and S2.

When the determination made in step S2 is NO, the processor 42 increments the number of error times “n” by “1” (n=n+1) in step S22. In step S23, the processor 42 determines whether or not the number of error times “n” at this time point has reached a predetermined threshold value nₜₕ (n=nₜₕ). The threshold value nₜₕ is predetermined by the operator (e.g., nₜₕ=100). The processor 42 proceeds to step S24 upon determining YES, or proceeds to step S3 upon determining NO and sequentially executes step S3 to step S8 described above.

In step S24, the processor 42 obtains a recommended temperature Tr. Here, when the determination made in step S23 is YES, it means that it is repeatedly determined nₜₕ (=100) times that the temperature T is outside the allowable range [Tₜₕ₁, Tₜₕ₂] (i.e., NO) in step S2. In this case, the cycle time tc of the work may increase.

For example, in a case where the allowable range [Tₜₕ₁, Tₜₕ₂] is determined in the teaching process TP or the calibration process CB as described above, the temperature error determination mentioned above may occur due to the temperature T1 or T2 acquired in the teaching process TP or the calibration process CB being inappropriately low or high. In this case, by executing the teaching process TP or the calibration process CB again at a more appropriate temperature T, it is possible to reduce the cycle time tc of the work while securing the accuracy of the detection operation DO.

Therefore, in the present embodiment, in step S24, the processor 42 obtains the recommended temperature Tr when the teaching process TP or the calibration process CB is executed again on the basis of a plurality of the temperatures T acquired each time step S1 of FIG. 9 is executed. As an example, the processor 42 obtains the temperature T acquired in the m-th (e.g., m=100) execution of step S1 as the recommended temperature Tr.

As another example, the processor 42 obtains, as the recommended temperature Tr, a mean value of the temperatures T collected while executing step S1 a predetermined number of times m. As still another example, the processor 42 may multiply the temperatures T collected while executing step S1 m times by weighting coefficients, and obtain a weighted mean value as the recommended temperature Tr. The processor 42 may obtain the recommended temperature Tr by any calculation using the collected temperatures T other than the mean value and the weighted mean value. In this way, the processor 42 obtains the recommended temperature Tr on the basis of the temperatures T collected in step S1 and stores the obtained recommended temperature Tr in the memory 44.

In step S25, the processor 42 outputs an alarm AL1 and the recommended temperature Tr obtained in step S24. As an example, the processor 42 generates the alarm AL1 saying “Temperature error determination frequently occurs. It is recommended to carry out the teaching process or the calibration process again.” as image data or sound data.

Then, the processor 42 outputs the generated alarm AL1 to the display device 52 or to a speaker (not illustrated) provided in the controller 18. This makes it possible to report the alarm AL1 to the operator by the image or sound. The processor 42 displays the recommended temperature Tr obtained in step S24 on the display device 52 (or outputs from the speaker) together with the alarm AL1. After step S25, the processor 42 ends the flow in FIG. 9 (or proceeds to step S6).

According to the present embodiment, for example, in a case where the allowable range [Tₜₕ₁, Tₜₕ₂] is determined on the basis of the temperature T1 or T2 acquired in the teaching process TP or the calibration process CB, the operator can easily recognize that there is a possibility that the temperature T1 or T2 is inappropriate. In addition, the operator can recognize that the teaching process TP or the calibration process CB needs to be performed again, and can automatically acquire the recommended temperature Tr when the teaching process TP or the calibration process CB is performed again. Note that step S24 may be omitted from the flow in FIG. 9. In this case, the processor 42 may output only the alarm AL1 in step S25.

Steps S21 to S25 in FIG. 9 can also be applied to the flow in FIG. 6. For example, after the flow in FIG. 6 is started, the processor 42 may execute step S21 and execute steps S22 to S25 when the determination made in step S2 of FIG. 6 is NO. Alternatively, the processor 42 may execute steps S22 to S25 when the determination made in step S12 of FIG. 7 is NO. In step S24 executed in this case, the processor 42 may obtain the recommended temperature Tr on the basis of the temperature T acquired each time step S11 of FIG. 7 is executed.

In the above-described step S25, the processor 42 may propose a modification of the computer program PG instead of outputting the alarm AL1 (or in addition to outputting the alarm AL1). For example, the computer program PG may include a robot program PG1 for executing the flow of FIG. 9 and a detection program PG2 for causing the imaging unit 14 to execute the detection operation DO of step S6.

In this case, the processor 42 may propose to modify the robot program PG1 so as to add an instruction code for additionally executing the cooling operation CO or warming-up operation WO in the flow of FIG. 9 (e.g., when the determination made in step S8 is NO). For example, the processor 42 may generate an alarm AL2 saying “Temperature error determination occurs frequently. It is recommended to add an instruction code of the cooling operation or the warming-up operation to the robot program.” and output the generated alarm to the display device 52 or the speaker. This makes it possible for the operator to automatically recognize that it is necessary to modify the robot program PG1 in order to prevent frequent temperature error determinations.

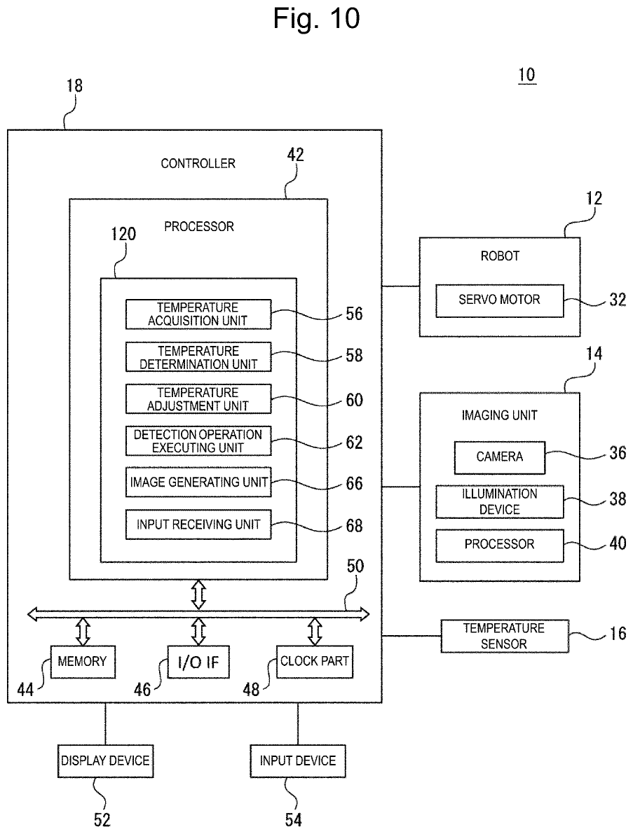

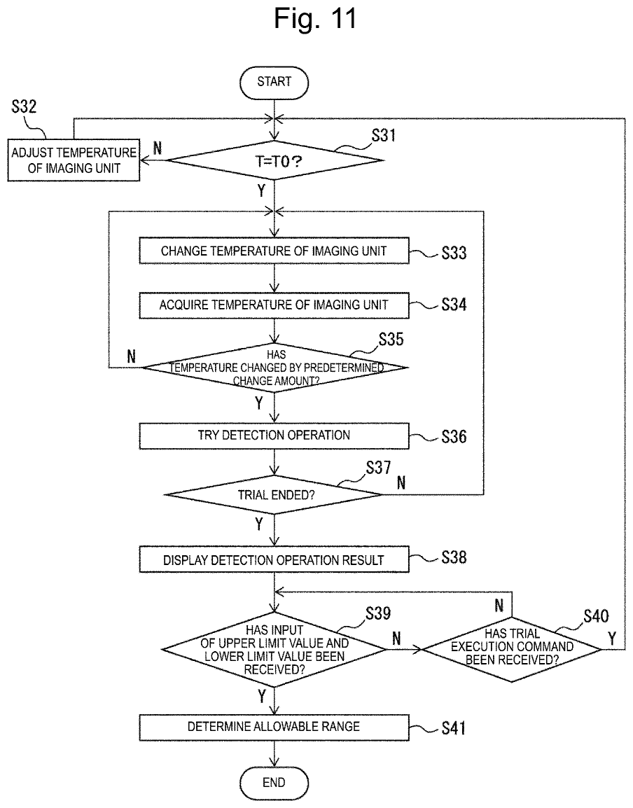

Next, still another method of determining the allowable range [Tₜₕ₁, Tₜₕ₂] will be described with reference to FIGS. 10 and 11. In the industrial machine 10 illustrated in FIG. 10, the processor 42 of the controller 18 executes the flow of FIG. 11 before the flow of FIG. 4, 6, or 9 in order to determine the allowable range [Tₜₕ₁, Tₜₕ₂]. The flow in FIG. 11 is started when the processor 42 receives an allowable range setting command from the operator, the host controller, or the computer program PG. Before the start of the flow in FIG. 11, the operator sets the workpiece W at the teaching position P0 by using the jig J.

In step S31, the processor 42 determines whether or not the temperature T of the imaging unit 14 has reached a predetermined initial temperature T0. Specifically, the processor 42 functions as the temperature acquisition unit 56 and acquires the temperature T of the imaging unit 14 measured by the temperature sensor 16 at this time point. Then, the processor 42 determines whether or not the acquired temperature T is equal to the initial temperature T0 (or whether or not the acquired temperature T falls within a range determined on the basis of the initial temperature T0). The initial temperature T0 is predetermined by the operator (e.g., T0=10° C. or 60° C.). The processor 42 proceeds to step S33 upon determining YES, or proceeds to step S32 upon determining NO.

In step S32, the processor 42 functions as the temperature adjustment unit 60 and adjusts the temperature T of the imaging unit 14. For example, when the determination made in the most recent step S31 is NO because the temperature T is lower than the initial temperature T0, the processor 42 executes the above-described warming-up operation WO. On the other hand, when the processor 42 determines NO because the temperature T is higher than the initial temperature T0 in the most recent step S31, the processor 42 executes the above-described cooling operation CO. After step S32, the processor 42 returns to step S31.

In contrast, when the determination made in step S31 is YES, the processor 42 functions as the temperature adjustment unit 60 and changes the temperature T of the imaging unit 14 in step S33. As an example, when the initial temperature T0 is set to 10° C., the processor 42 raises the temperature T of the imaging unit 14 by executing the warming-up operation WO described above. As another example, when the initial temperature T0 is set to 60° C., the processor 42 lowers the temperature T of the imaging unit 14 by executing the cooling operation CO described above.

In step S34, the processor 42 functions as the temperature acquisition unit 56 to acquire the temperature T of the imaging unit 14 as in step S1 described above. In step S35, on the basis of the temperature T acquired in step S34, the processor 42 determines whether or not the temperature T of the imaging unit 14 has been changed (i.e., raised or lowered) by a predetermined change amount δT by executing the most recent step S33.

The change amount δT is predetermined by the operator (e.g., δT=5° C.). The processor 42 proceeds to step S36 upon determining YES, or returns to step S33 upon determining NO. In this way, the processor 42 changes the temperature T of the imaging unit 14 by the predetermined change amount δT by executing a loop of step S33 to step S35.

In step S36, the processor 42 functions as the detection operation executing unit 62, and performs a trial of the detection operation DO. Specifically, the processor 42 arranges the imaging unit 14 at the imaging position IP1 by the robot 12. Then, the processor 42 causes the illumination device 38 to execute the lighting operation LO to irradiate the workpiece W with light, and causes the imaging unit 14 to execute the imaging operation IO to image the workpiece W. The imaging conditions CDi when the imaging operation IO is executed or the lighting conditions CDI when the lighting operation LO is executed in step S36 may be completely identical to those in step S6 described above, or may be at least partially different therefrom. As a result of the detection operation DO, the processor 42 acquires detection result data RD.

The detection result data RD includes, for example, the imaged image data ID and detection result parameters PRr. The detection result parameters PRr are parameters related to the accuracy of the result of the detection operation DO, and may include, for example, a detecting position P (x, y, z) of the workpiece W acquired as the result of the detection operation DO, and a score α, contrast β and distortion γ of the image data ID. The score α indicates, for example, the degree of coincidence between the shape of the workpiece W detected from the image data ID and the teaching shape TS taught in advance.

The processor 42 stores the acquired detection result data RD (the image data ID and the detection result parameters PRr) in the memory 44. The detection result parameters PRr may include any parameter related to the accuracy of the result of the detection operation DO other than the detecting position P, the score a, the contrast B, and the distortion γ. For example, the detection result parameters PRr may further include a deviation amount OP between the detecting position P and the teaching position P0 taught in advance.

The detection result data RD may include any data indicating a result of the detection operation DO other than the image data ID and the detection result parameters PRr. In the case where the determination made in step S31 described above is YES, the trial of the detection operation DO may be performed in the same manner as in step S36, and the detection result data RD at the initial temperature T0 may be further acquired.

In step S37, the processor 42 determines whether or not to end the trial of the detection operation DO. For example, the operator optionally sets the initial temperature T0, the change amount δT, and a maximum temperature Tmax or a minimum temperature Tmin in order to change (raise or lower) the temperature T of the imaging unit 14 from the initial temperature T0 (=10° C. or 60° C.) to the maximum temperature Tmax (=60° C.) or to the minimum temperature Tmin (=10° C.) by the change amount δT (=5° C.) each through a loop of step S33 to step S37.

In this case, prior to the flow in FIG. 11, the operator may operate the input device 54 to input the initial temperature T0, the change amount δT, and the maximum temperature Tmax or the minimum temperature Tmin. The processor 42 may determine YES in step S37 when the temperature T at the time the processor 42 determined YES in step S35 has reached the maximum temperature Tmax or the minimum temperature Tmin.

The processor 42 proceeds to step S38 upon determining YES, or returns to step S33 upon determining NO. In this way, the processor 42 repeatedly executes the loop of steps S33 to S37 until the processor 42 determines YES in step S37, and every time the temperature T is changed by the change amount δT, the processor 42 performs the trial of the detection operation DO in step S36 to acquire the detection result data RD.

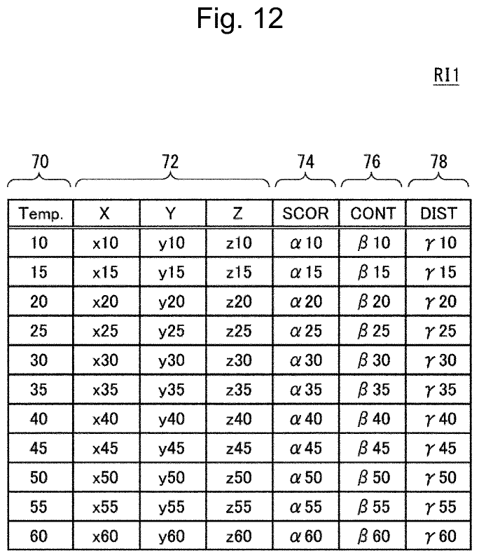

In step S38, the processor 42 displays the result of the detection operation DO executed in step S36 described above (i.e., the detection result data RD). Specifically, the processor 42 generates a detection result image RI for display of the detection result data RD, and displays the generated image on the display device 52. FIG. 12 illustrates a result list image RI1 as an example of the detection result image RI.

The result list image RI1 indicates, of the detection result data RD, the detection result parameters PRr (the detecting position P, the score a, the contrast B, and the distortion γ) in list form for each temperature T, at which the trial of the detection operation DO is performed. To be specific, the result list image RI1 includes an image region 70 indicating the temperature T, an image region 72 indicating the detecting position P (x, y, z), an image region 74 indicating the score a, an image region 76 indicating the contrast B, and an image region 78 indicating the distortion y. The operator can easily confirm the relationship between the temperature T, at which the trial of the detection operation DO is performed in step S36, and the detection result parameters PRr by referring to the result list image RI1.

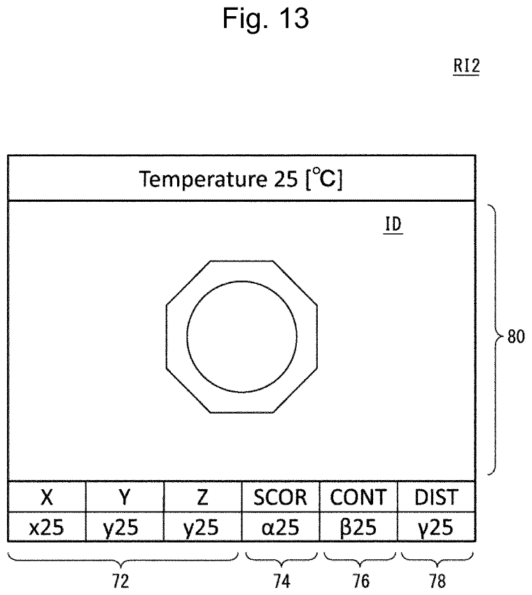

FIG. 13 illustrates a result detail image RI2 as another example of the detection result image RI. The result detail image RI2 depicts details of the detection result data RD (the image data ID, the detecting position P, the score a, the contrast β, and the distortion γ) at a specific temperature T (in the example of FIG. 13, T=25° C.). To be specific, the result detail image RI2 includes an image region 80 indicating the image data ID, the image region 72 indicating the detecting position P (x, y, z), the image region 74 indicating the score a, the image region 76 indicating the contrast B, and the image region 78 indicating the distortion y. The operator can easily confirm the details of the result of the detection operation DO at the specific temperature T by referring to the result detail image RI2.

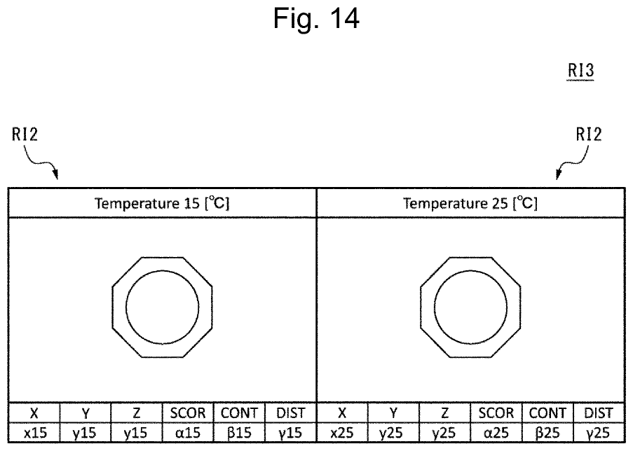

FIG. 14 illustrates a result comparison image RI3 as still another example of the detection result image RI. In the result comparison image RI3, the result detail images RI2 at the plurality of temperatures T (15° C. and 25° C. in the example of FIG. 14) are displayed side by side. By referring to the result comparison image RI3, the operator can compare and examine the details of the results of the detection operations DO at the plurality of temperatures T. The result comparison image RI3 in FIG. 14 displays two result detail images RI2 at the temperatures T being 15° C. and 25° C. side by side, but the result comparison image RI3 may display the result detail images RI2 at three or more temperatures T side by side.

The processor 42 may selectively display the result list image RI1 of FIG. 12, the result detail image RI2 of FIG. 13, or the result comparison image RI3 of FIG. 14 in response to an input operation performed on the input device 54 by the operator. For example, at the time when the result list image RI1 of FIG. 12 is displayed on the display device 52, the operator operates the input device 54 to select one of the temperatures T (or the detection result parameters PRr) in the result list image RI1 by clicking on the image. In response to this input operation, the processor 42 may display the result detail image RI2 (FIG. 13) corresponding to the selected temperature T on the display device 52.

Further, the operator operates the input device 54 to select at least two of the temperatures T (or the detection result parameters PRr) in the result list image RI1 displayed on the display device 52 by clicking on the image. In response to this input operation, the processor 42 may display the result comparison image RI3 (FIG. 14) corresponding to the selected plurality of temperatures T, on the display device 52.

As described above, in the present embodiment, the processor 42 generates the detection result image RI (specifically, the result list image RI1, the result detail image RI2, and the result comparison image RI3) displaying the results (the detection result data RD) of the plurality of detection operations DO repeatedly tried in step S36. Accordingly, the processor 42 functions as an image generating unit 66 (FIG. 10) configured to generate the detection result image RI.

Referring to FIG. 11 again, in step S39, the processor 42 determines whether or not input of the lower limit value Tₜₕ₁ and the upper limit value Tₜₕ₂ of the allowable range [Tₜₕ₁, Tₜₕ₂] has been received. Here, the operator can determine the lower limit value Tₜₕ₁ and the upper limit value Tₜₕ₂ of the temperature T capable of securing the accuracy of the detection operation DO, by examining the detection result data RD depicted in the detection result image RI (the result list image RI1, the result detail image RI2, and the result comparison image RI3) displayed in step S38 described above.

For example, by comparing the detecting position P (x, y, z) depicted in the detection result image RI with the teaching position P0 (x0, y0, z0) taught in advance, the operator can be aware of a deviation of the detecting position P from the teaching position P0, and as a result, the operator can recognize the relationship between the deviation and the temperature T. In addition, the operator can recognize the relationship between the temperature T and the score α, the contrast β and the distortion γ, which may affect the accuracy of the detection operation DO.

The operator operates the input device 54 to input the lower limit value Tₜₕ₁ and the upper limit value Tₜₕ₂ determined as a result of examining the detection result image RI. At this time, the processor 42 may generate an input image for receiving the input of the lower limit value Tₜₕ₁ and the upper limit value Tₜₕ₂, and display the generated input image on the display device 52, together with the detection result image RI (or by switching from the detection result image RI).

The processor 42 determines YES in step S39 and proceeds to step S41 in the case where the input of the lower limit value Tₜₕ₁ and the upper limit value Tₜₕ₂ is received, whereas the processor 42 proceeds to step S40 upon determining NO. Thus, in the present embodiment, the processor 42 functions as an input receiving unit 68 (FIG. 10) configured to receive the input of the lower limit value Tₜₕ₁ and the upper limit value Tₜₕ₂.

In step S40, the processor 42 determines whether or not a trial execution command for executing the trial of the detection operation DO again has been received from the operator. For example, the operator performs the trial of the detection operation DO while raising the temperature T stepwise from the initial temperature T0 being 10° C. to the maximum temperature Tmax being 60° C. through the first-time loop of step S31 to step S40.

Subsequently, the operator performs the trial of the detection operation DO while lowering the temperature T stepwise from the initial temperature T0 being 60° C. to the minimum temperature Tmin being 10° C. through the second-time loop of step S31 to step S40. In this way, in order to execute the loop of step S31 to step S40 a plurality of times, the operator may give the trial execution command to the processor 42 in step S40. The processor 42 returns to step S31 upon determining YES, or returns to step S39 upon determining NO.

In step S41, the processor 42 determines the allowable range [Tₜₕ₁, Tₜₕ₂] by the lower limit value Tₜₕ₁ and the upper limit value Tₜₕ₂ received in the immediately preceding step S39, and stores the determined allowable range in the memory 44. The processor 42 executes the flow in FIG. 4, 6, or 9 by referring to the allowable range [Tₜₕ₁, Tₜₕ₂] determined as described above.

As discussed above, in the industrial machine 10 illustrated in FIG. 10, the processor 42 functions as the temperature acquisition unit 56, the temperature determination unit 58, the temperature adjustment unit 60, the detection operation executing unit 62, the image generating unit 66, and the input receiving unit 68, so as to manage the temperature T of the imaging unit 14. Accordingly, the temperature acquisition unit 56, the temperature determination unit 58, the temperature adjustment unit 60, the detection operation executing unit 62, the image generating unit 66, and the input receiving unit 68 constitute an apparatus 120 configured to manage the temperature T of the imaging unit 14.

In the apparatus 120, in order to determine the allowable range [Tₜₕ₁, Tₜₕ₂], the temperature adjustment unit 60 changes the temperature T (step S33) by executing the warming-up operation WO or the cooling operation CO before the work (step S6). Then, the detection operation executing unit 62 performs the trial of the detection operation DO when the temperature adjustment unit 60 changes the temperature T (step S36). This configuration makes it possible to clarify the relationship between the temperature T and the result of the detection operation DO. Thus, it is possible to determine the allowable range [Tₜₕ₁, Tₜₕ₂] so that the accuracy of the detection operation DO can be secured.

In the apparatus 120, the image generating unit 66 generates the detection result image RI displaying the result of the plurality of detection operations DO repeatedly tried by the detection operation executing unit 62 (step S38). Then, the input receiving unit 68 receives the input of the lower limit value Tₜₕ₁ and the upper limit value Tₜₕ₂ determined by the operator on the basis of the result of the detection operations DO (step S39). According to this configuration, the operator can easily examine the relationship between the temperature T and the detection result by referring to the detection result image RI. As a result, the operator can appropriately determine the lower limit value Tₜₕ₁ and the upper limit value Tₜₕ₂ of the allowable range [Tₜₕ₁, Tₜₕ₂].

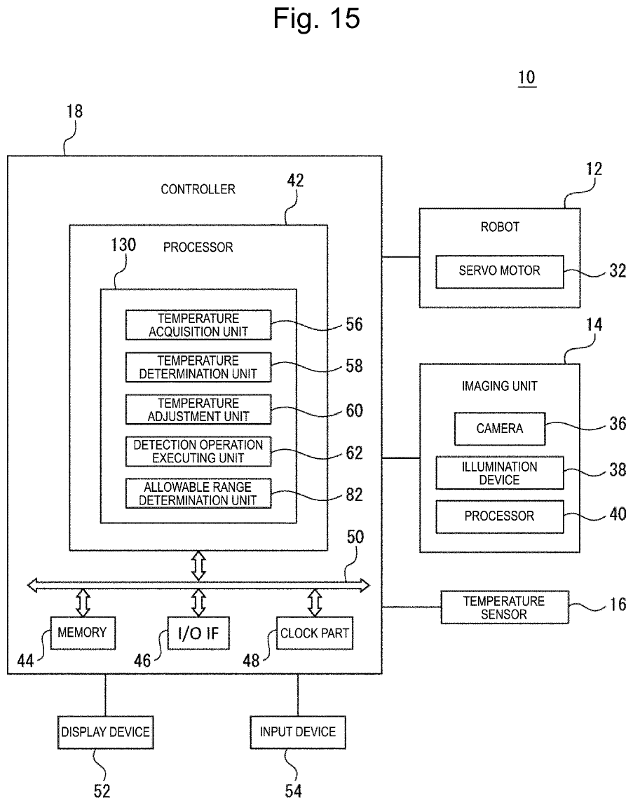

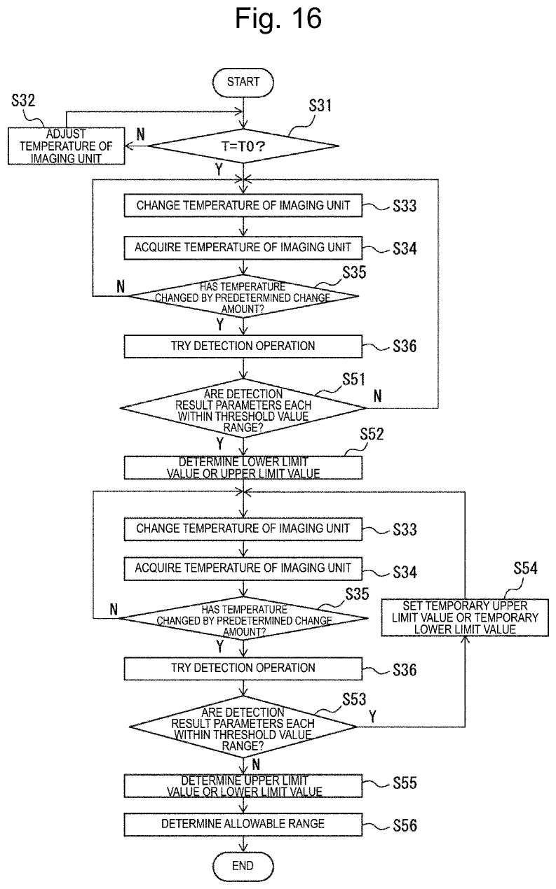

Next, still another method of determining the allowable range [Tₜₕ₁, Tₜₕ₂] will be described with reference to FIGS. 15 and 16. In the industrial machine 10 illustrated in FIG. 15, the processor 42 of the controller 18 executes a flow of FIG. 16 before the flow of FIG. 4, 6, or 9 in order to determine the allowable range [Tₜₕ₁, Tₜₕ₂]. Note that, in the flow illustrated in FIG. 16, processing similar to that in the flow of FIG. 11 is denoted by the same step number, and redundant description thereof will be omitted.

The flow in FIG. 16 is started when the processor 42 receives an allowable range setting command from the operator, the host controller, or the computer program PG. After the flow illustrated in FIG. 16 is started, the processor 42 sequentially executes step S31 to step S36 discussed above. In the following description, a case will be explained where the processor 42 raises the temperature T from the initial temperature T0 (=10° C.) by the change amount δT in steps S33 to S35 in FIG. 16.

In step S51, the processor 42 determines whether or not the detection result parameters PRr included in the detection result data RD acquired by executing the immediately preceding step S36 fall within threshold value ranges capable of securing the accuracy of the detection operation DO. As an example, +5% threshold value ranges of [x0×0.95, x0×1.05], [y0×0.95, y0×1.05], and [z0×0.95, z0×1.05] are respectively set for the coordinates x0, y0, and z0 of the teaching position P0 taught in advance.

In this case, the processor 42 determines whether or not the coordinates x, y, and z of the detecting position P (x, y, z) acquired as the detection result parameters PRr in the immediately preceding step S36 respectively fall within the threshold value ranges of [x0×0.95, x0×1.05], [y0×0.95, y0×1.05], and [z0×0.95, z0×1.05] (i.e., x0× 0.95≤ x≤ x0×1.05, y0×0.95<y≤ y0×1.05, and z0×0.95≤ z≤ z0×1.05).

When each of the coordinates x, y, and z of the detecting position P falls within the threshold value range, it can be considered that the accuracy of the detection operation DO is secured. Therefore, when at least one of the coordinates x, y, and z is outside the threshold value range, the processor 42 determines NO in step S51. The threshold value ranges are not limited to +5% of the coordinates of the detecting position P, and may each be a range of any percentage such as +1% or +10%.

As another example, in the immediately preceding step S36, the processor 42 acquires, as the detection result parameter PRr, a deviation amount OP between the detecting position P (x, y, z) and the teaching position P0 (x0, y0, z0) taught in advance. The deviation amount OP is obtained by the calculation of ((x−x0)²+(y−y0)²+(z−z0)²)^{1/2}. When the deviation amount OP exceeds a predetermined threshold value δPₜₕ (i.e., δP>δPₜₕ), the processor 42 determines that the deviation amount OP is outside the threshold value range capable of securing the accuracy of the detection operation DO (i.e., NO).

As still another example, when the score α, the contrast β, or the distortion γ acquired as the detection result parameter PRr in the immediately preceding step S36 is smaller or larger than a predetermined threshold value αₜₕ, βₜₕ, or γₜₕ (e.g., α<αₜₕ, β<βₜₕ, or γ>γₜₕ), the processor 42 determines that the score α, contrast β, or distortion y is outside the threshold value range capable of securing the accuracy of the detection operation DO (i.e., NO).

The processor 42 may determine whether or not all the detection result parameters PRr including the coordinates x, y, and z of the detecting position P, the deviation amount OP, the score α, the contrast B, and the distortion y fall within the respective threshold value ranges, and may determine NO in step S51 when at least one of the detection result parameters PRr is outside the threshold value range.

The processor 42 returns to step S33 upon determining NO, or proceeds to step S52 upon determining YES. When the determination made in step S51 is YES, it can be considered that the temperature T raised stepwise in step S33 exceeds the lower limit value Tₜₕ₁ of the allowable range [Tₜₕ₁, Tₜₕ₂] capable of securing the accuracy of the detection operation DO and falls within the allowable range [Tₜₕ₁, Tₜₕ₂].

In this way, the processor 42 repeatedly executes a loop of steps S33 to S36 and step S51 until the processor 42 determines YES in step S51, and every time the temperature T of the imaging unit 14 is raised by the change amount δT, the processor 42 repeatedly performs the trial of the detection operation DO. Each time the trial of the detection operation DO is performed, it is determined whether or not the detection result parameters PRr each fall within the threshold value range capable of securing the accuracy of the detection operation DO, thereby searching for the lower limit value Tₜₕ₁ Of the temperature T capable of securing the accuracy mentioned above. That is, in the present embodiment, the processor 42 functions as an allowable range determination unit 82 (FIG. 15) configured to automatically determine the lower limit value Tₜₕ₁ of the allowable range [Tₜₕ₁, Tₜₕ₂] on the basis of the results of the plurality of detection operations repeatedly tried (specifically, the detection result parameters PRr).

In step S52, the processor 42 functions as the allowable range determination unit 82 to determine the lower limit value Tₜₕ₁ of the allowable range [Tₜₕ₁, Tₜₕ₂] on the basis of the determination result in step S51. To be specific, the processor 42 determines the temperature T at the time when the processor 42 determines YES in the immediately preceding step S51 as the lower limit value Tₜₕ₁, and stores the determined value in the memory 44. After step S52, the processor 42 executes steps S33 to S36.

In step S53, the processor 42 functions as the allowable range determination unit 82 to determine whether or not the detection result parameters PRr (the coordinates of the detecting position P, the deviation amount OP, the score α, the contrast B, and the distortion y) acquired by executing the immediately preceding step S36 respectively fall within the threshold value ranges capable of securing the accuracy of the detection operation DO, similarly to step S51 described above. The processor 42 proceeds to step S54 upon determining YES, or proceeds to step S55 upon determining NO.

In step S54, the processor 42 functions as the allowable range determination unit 82 to set a temporary upper limit value Tₜₕ₂′ as a temporary setting value of the upper limit value Tₜₕ₂ of the allowable range [Tₜₕ₁, Tₜₕ₂]. To be specific, the processor 42 determines the temperature T at the time when the processor 42 determines YES in the immediately preceding step S53 as the temporary upper limit value Tₜₕ₂′, and stores the temporary value in the memory 44. Thus, after step S52 discussed above, the processor 42 repeatedly executes a loop of steps S33 to S36, S53, and S54 until determining NO in step S53. Then, the processor 42 updates the temporary upper limit value Tₜₕ₂′ stored in the memory 44 every time the processor 42 executes step S54.

On the other hand, when the determination made in step S53 is NO, it can be considered that the temperature T raised stepwise in step S33 exceeds the upper limit value Tₜₕ₂ of the allowable range [Tₜₕ₁, Tₜₕ₂] capable of securing the accuracy of the detection operation DO and comes to be outside the allowable range [Tₜₕ₁, Tₜₕ₂]. In this manner, the processor 42 repeatedly executes the loop of steps S33 to S36, S53, and S54, thereby searching for the upper limit value Tₜₕ₂ of the temperature T capable of securing the accuracy of the detection operation DO.

In step S55, the processor 42 functions as the allowable range determination unit 82 to determine the upper limit value Tₜₕ₂ on the basis of the determination result in step S53. To be specific, the processor 42 determines the temporary upper limit value Tₜₕ₂′ stored in the memory 44 at the time point when the determination made in the immediately preceding step S53 is NO as the official upper limit value Tₜₕ₂ of the allowable range [Tₜₕ₁, Tₜₕ₂], and stores the official value in the memory 44. The temporary upper limit value Tₜₕ₂′ stored at this time point is the temperature T when the determination made most recently in step S53 is YES (in other words, the temperature T acquired in the two-time earlier step S34).

In step S56, the processor 42 determines the allowable range [Tₜₕ₁, Tₜₕ₂] by the lower limit value Tₜₕ₁ and the upper limit value Tₜₕ₂ determined in step S52 and step S55, and stores the determined allowable range in the memory 44. The processor 42 executes the flow in FIG. 4, 6, or 9 by referring to the allowable range [Tₜₕ₁, Tₜₕ₂] determined as described above.

As discussed above, in the industrial machine 10 illustrated in FIG. 15, the processor 42 functions as the temperature acquisition unit 56, the temperature determination unit 58, the temperature adjustment unit 60, the detection operation executing unit 62, and the allowable range determination unit 82, so as to manage the temperature T of the imaging unit 14. Accordingly, the temperature acquisition unit 56, the temperature determination unit 58, the temperature adjustment unit 60, the detection operation executing unit 62, and the allowable range determination unit 82 constitute an apparatus 130 configured to manage the temperature T of the imaging unit 14.

In the apparatus 130, the allowable range determination unit 82 automatically determines the lower limit value Tₜₕ₁ and the upper limit value Tₜₕ₂ of the allowable range [Tₜₕ₁, Tₜₕ₂] on the basis of the results (specifically, the detection result parameters PRr) of the plurality of detection operations DO (step S36) repeatedly tried by the detection operation executing unit 62. According to this configuration, since the allowable range [Tₜₕ₁, Tₜₕ₂] can be automatically set, the burden on the operator can be reduced.

In the apparatus 130, each time the detection operation executing unit 62 performs the trial of the detection operation DO (step S36), the allowable range determination unit 82 determines whether or not the detection result parameters PRr (the coordinates of the detecting position P, the deviation amount OP, the score α, the contrast B, the distortion y, and the like) included in the result of the detection operation DO fall within the threshold value ranges capable of securing the accuracy of the detection operation DO (steps S51 and S53).

Then, the allowable range determination unit 82 determines the lower limit value Tₜₕ₁ and the upper limit value Tₜₕ₂ on the basis of the determination results of the detection result parameters PRr. According to this configuration, for example, as illustrated in FIG. 16, the flow of setting the allowable range [Tₜₕ₁, Tₜₕ₂] can be automated by a relatively simple algorithm.

In the present embodiment, the case has been described where the processor 42 raises the temperature T from the initial temperature T0 (=10° C.) by the change amount δT in steps S33 to S35 in FIG. 16. However, in steps S33 to S35 in FIG. 16, the processor 42 may lower the temperature T from the initial temperature T0 (=60° C.) by the change amount δT.

In this case, in step S52, the processor 42 determines the temperature T at the time when the processor 42 determines YES in the immediately preceding step S51 as the upper limit value Tₜₕ₂. In step S54, the processor 42 stores the temperature T at the time when the processor 42 determines YES in the immediately preceding step S53 in the memory 44 as a temporary lower limit value Tₜₕ₁′. Then, in step S55, the processor 42 determines the temporary lower limit value Tₜₕ₁′ stored in the memory 44 at the time point when the determination made in the immediately preceding step S53 is NO, as the official lower limit value Tₜₕ₁ of the allowable range [Tₜₕ₁, Tₜₕ₂].

Various changes can be added to the flow in FIG. 16. For example, steps S33 to S36 and S53 to S55 after step S52 may be omitted from the flow in FIG. 16. In this case, the processor 42 may change (i.e., raise or lower) the temperature T from the initial temperature T0 (=10° C. or 60° C.) by the change amount δT in steps S33 to S35, and may determine the lower limit value Tₜₕ₁ or the upper limit value Tₜₕ₂ in step S52. That is, in this case, the processor 42 automatically determines one of the lower limit value Tₜₕ₁ and the upper limit value Tₜₕ₂. Furthermore, steps S31 and S32 may be omitted from the flow in FIG. 11 or 16. In this case, the initial temperature T0 may be set to the ambient temperature at that time.

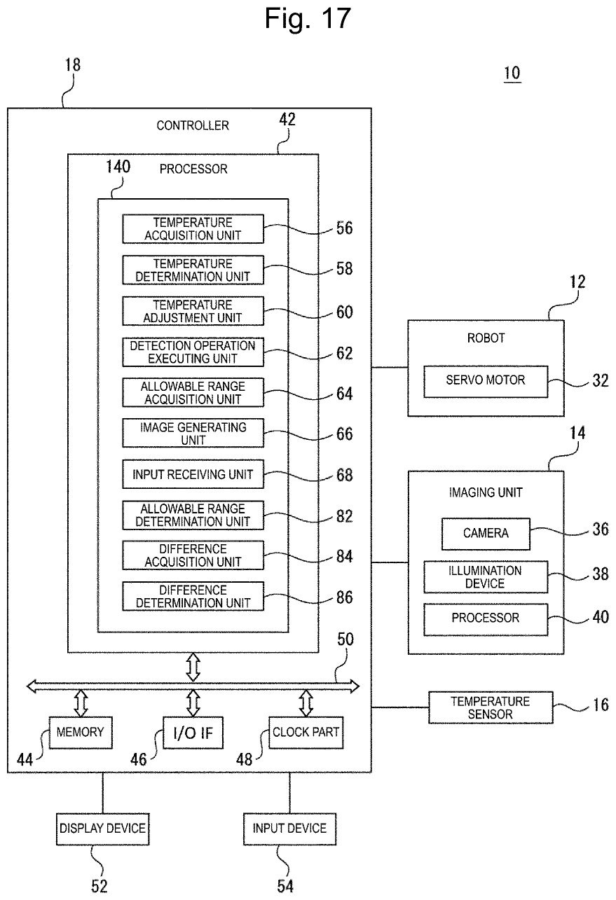

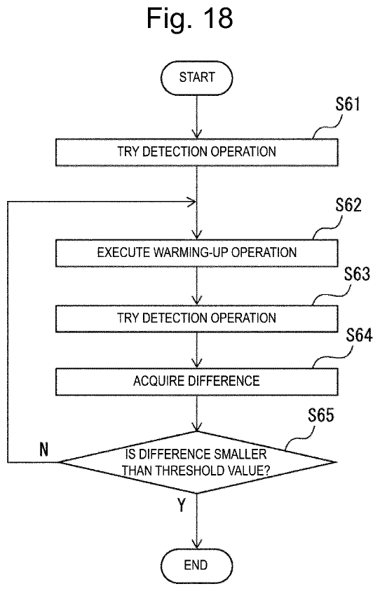

Next, another function of the industrial machine 10 will be described with reference to FIGS. 17 and 18. In the industrial machine 10 illustrated in FIG. 17, the processor 42 of the controller 18 functions as an apparatus 140 including the temperature acquisition unit 56, the temperature determination unit 58, the temperature adjustment unit 60, the detection operation executing unit 62, the allowable range acquisition unit 64, the image generating unit 66, the input receiving unit 68, the allowable range determination unit 82, a difference acquisition unit 84, and a difference determination unit 86. Accordingly, the processor 42 can execute the functions of the industrial machines 10 illustrated in FIGS. 2, 8, 10, and 15 (i.e., the flows of FIGS. 4, 6, 9, 11, and 16).

In the present embodiment, the processor 42 executes a warming-up scheme illustrated in FIG. 18 as a preparation process for the work immediately before (or immediately after) the start of the flow in FIG. 4, 6, or 9. A flow illustrated in FIG. 18 is started when the imaging unit 14 is activated (i.e., powered on) for the flow in FIG. 4, 6, or 9.

In step S61, the processor 42 functions as the detection operation executing unit 62 as in step S36 described above, and performs the trial of the detection operation DO. As a result, the processor 42 acquires the detection result parameters PRr (the detecting position P, the score α, the contrast B, the distortion y, and the like). In step S62, the processor 42 functions as the temperature adjustment unit 60, and executes the warming-up operation WO as in step S5 described above. In step S63, the processor 42 functions as the detection operation executing unit 62 as in step S61 described above, and performs the trial of the detection operation DO. As a result, the processor 42 acquires the detection result parameters PRr (the detecting position P, the score α, the contrast B, the distortion y, and the like) again.

In step S64, the processor 42 acquires a difference δrᵢ between a detection result parameter PRrᵢ included in the result of a detection operation DOᵢ (first detection operation) most recently tried and a detection result parameter PRrᵢ₋₁ included in the result of a detection operation DOᵢ₋₁ (second detection operation) tried before the detection operation DOᵢ. As an example, the processor 42 acquires a deviation amount between a detecting position Pᵢ (xᵢ, yᵢ, zᵢ) acquired as the detection result parameter PRrᵢ and a detecting position Pᵢ₋₁ (xᵢ₋₁, yᵢ₋₁, zᵢ₋₁) acquired as the detection result parameter PRrᵢ₋₁, as a difference δr1ᵢ. The deviation amount is obtained by the calculation of ((xᵢ−xᵢ₋₁) 2+ (yᵢ−yᵢ₋₁)²+ (zᵢ−zᵢ₋₁)²)^{1/2}.

As another example, the processor 42 acquires a difference δr2ᵢ equal to |αᵢ−αᵢ₋₁|, a difference δr3ᵢ equal to |βᵢ−βᵢ₋₁|, or a difference δr4ᵢ equal to |γᵢ−γᵢ₋₁| between a score αᵢ, a contrast βᵢ or a distortion γᵢ acquired as the detection result parameter PRrᵢ and a score αᵢ₋₁, a contrast βᵢ₋₁ or a distortion γᵢ₋₁ acquired as the detection result parameter PRrᵢ₋₁.

As described above, in the present embodiment, the processor 42 functions as the difference acquisition unit 84 (FIG. 17) configured to acquire the difference δrᵢ (δr1ᵢ, δr2ᵢ, δr3ᵢ, or δr4ᵢ) between the detection result parameter PRrᵢ and the detection result parameter PRrᵢ₋₁. For example, when the processor 42 executes step S64 after continuously executing steps S61, S62, and S63, the processor 42 acquires a difference δr₁ between a detection result parameter PRr₂ acquired in the immediately preceding step S63 and a detection result parameter PRr₁ acquired in step S61 executed before step S63 mentioned above.

In step S65, the processor 42 determines whether or not the difference δrᵢ (e.g., δr1ᵢ, δr2ᵢ, δr3ᵢ, or δr4ᵢ) acquired in the immediately preceding step S64 is smaller than a predetermined threshold value Orth. In a case of δrᵢ<δrₜₕ, the processor 42 determines YES and ends the flow in FIG. 18, and then executes the flow in FIG. 4, 6, or 9 so as to sequentially execute step S6 and step S7 discussed above.

On the other hand, in a case of δnᵢ>δrₜₕ, the processor 42 determines NO, and returns to step S62. In this manner, in the present embodiment, the processor 42 functions as the difference determination unit 86 (FIG. 17) configured to determine whether or not the difference δrᵢ (e.g., δr1ᵢ, δr2ᵢ, δr3ᵢ, or δr4ᵢ) is smaller than the predetermined threshold value Orth.

As described above, the processor 42 functions as the apparatus 140 configured to execute the warming-up scheme illustrated in FIG. 18 as the preparation process for the work. In the apparatus 140, the temperature adjustment unit 60 executes the warming-up operation WO (step S62) when the imaging unit 14 is activated (after the power is turned on), and the detection operation executing unit 62 repeatedly performs the trial of the detection operation DO (step S63) each time the temperature adjustment unit 60 executes the warming-up operation WO.

The difference acquisition unit 84 acquires the difference δrᵢ between the detection result parameter PRrᵢ included in the result of the first detection operation DOᵢ tried by the detection operation executing unit 62 and the detection result parameter PRrᵢ₋₁ included in the result of the second detection operation DOᵢ₋₁ tried by the detection operation executing unit 62 before the first detection operation DOᵢ (step S64). Then, the difference determination unit 86 determines whether or not the difference δrᵢ acquired by the difference acquisition unit 84 is smaller than the predetermined threshold value Orth (step S65). When the difference determination unit 86 determines that the difference δrᵢ is smaller than the threshold value δrₜₕ (YES in step S65), the detection operation executing unit 62 executes the detection operation DO for the work (step S6).

After the imaging unit 14 (i.e., the camera 36, the illumination device 38, and the processor 40) is activated (e.g., powered on), since the temperature T of the imaging unit 14 rapidly rises, there is a possibility that the accuracy of the detection operation DO is unstable. Then, in the present embodiment, the warming-up operation WO is executed until a variation (i.e., difference δr) in the detection result parameters PRr acquired when the trial of the detection operation DO is repeatedly performed becomes small by executing the warming-up scheme illustrated in FIG. 18. This configuration makes it possible to stabilize the accuracy of the detection operation DO to be executed thereafter.

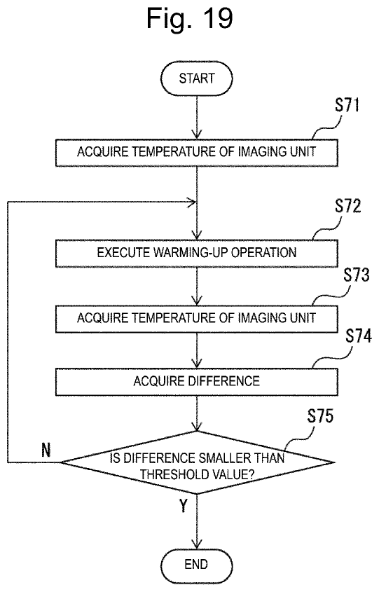

Next, another example of the warming-up scheme will be described with reference to FIG. 19. The processor 42 executes the warming-up scheme illustrated in FIG. 19 as a preparation process for the work immediately before (or immediately after) the start of the flow in FIG. 4, 6, or 9. In step S71, the processor 42 functions as the temperature acquisition unit 56 to acquire the temperature T of the imaging unit 14 as in step S1 described above. In step S72, the processor 42 functions as the temperature adjustment unit 60 as in step S62 described above, and executes the warming-up operation WO.

In step S73, the processor 42 functions as the temperature acquisition unit 56 to acquire the temperature T of the imaging unit 14 as in step S71 described above. In step S74, the processor 42 functions as the difference acquisition unit 84 to acquire a difference δMᵢ (=Tᵢ−Tᵢ₋₁) between a temperature Tᵢ (first temperature) acquired in the immediately preceding step S73 and a temperature Tᵢ₋₁ (second temperature) acquired before the temperature Tᵢ.

In step S75, the processor 42 functions as the difference determination unit 86, and determines whether or not the difference δMᵢ acquired in the immediately preceding step S74 is smaller than a predetermined threshold value δMₜₕ. In a case of δMᵢ<δMₜₕ, the processor 42 determines YES and ends the flow in FIG. 19, and then executes the flow in FIG. 4, 6, or 9 so as to sequentially execute step S6 and step S7 discussed above. On the other hand, in a case of δMᵢ>δMₜₕ, the processor 42 determines NO, and returns to step S72.

As described above, the processor 42 functions as the apparatus 140 configured to execute the warming-up scheme illustrated in FIG. 19 as the preparation process for the work. In the apparatus 140, the temperature acquisition unit 56 acquires the temperature T repeatedly measured by the temperature sensors 16 each time the temperature adjustment unit 60 executes the warming-up operation WO (step S73). The difference acquisition unit 84 acquires the difference δMᵢ between the temperature Tᵢ acquired by the temperature acquisition unit 56 and the temperature Tᵢ₋₁ acquired by the temperature acquisition unit 56 before the temperature Tᵢ (step S74). Then, the difference determination unit 86 determines whether or not the difference δMᵢ acquired by the difference acquisition unit 84 is smaller than the predetermined threshold value δMₜₕ (step S75).

When the difference determination unit 86 determines that the difference δMᵢ is smaller than the threshold value δMₜₕ (YES in step S75), the detection operation executing unit 62 executes the detection operation DO for the work (step S6). This configuration makes it possible to stabilize the accuracy of the detection operation DO to be executed after the flow in FIG. 19, as in the flow in FIG. 18.

The processor 42 may execute the functions of the industrial machine 10 illustrated in FIGS. 2, 8, 10, 15, and 17 (i.e., the flows in FIGS. 4, 6, 9, 11, 16, 18, and 19) in accordance with the computer program PG stored in advance in the memory 44. The functions of the temperature acquisition unit 56, the temperature determination unit 58, the temperature adjustment unit 60, the detection operation executing unit 62, the allowable range acquisition unit 64, the image generating unit 66, the input receiving unit 68, the allowable range determination unit 82, the difference acquisition unit 84, and the difference determination unit 86 executed by the processor 42 may be function modules implemented by the computer program PG.

In the above-described embodiment, the case where the camera 36 and the illumination device 38 are integrally incorporated in the housing 34 has been described. However, the present invention is not limited thereto, and the camera 36 and the illumination device 38 may be provided as separate devices in the imaging unit 14. In this case, the temperature sensor 16 may be provided in one of the camera 36 and the illumination device 38, and measure the temperature T of the one thereof.

Alternatively, the temperature sensor 16 may include a first temperature sensor 16A provided to the camera 36 to measure a temperature Tc of the camera 36 and a second temperature sensor 16B provided to the illumination device 38 to measure a temperature TI of the illumination device 38. In this case, the processor 42 functions as the apparatus 100, 110, 120, 130, or 140 configured to execute a flow FL1 for managing the temperature Tc of the camera 36.

In the flow FL1, the processor 42 may execute S1 to S5 in FIG. 4, steps S1, S2 and S10 in FIG. 6, or S21, S1, S2, S22 to S25 and S3 to S5 in FIG. 9 on the basis of the temperature Tc of the camera 36 acquired by the processor 42 serving as the temperature acquisition unit 56. In the warming-up operation WO of step S5 executed in the flow FL1, the processor 42 executes, for example, the above-described simulative imaging operation IO or arithmetic processing CL.

On the other hand, the processor 42 functions as the apparatus 100, 110, 120, 130, or 140 configured to execute a flow FL2 for managing the temperature TI of the illumination device 38 in parallel to the flow FL1 for the camera 36. In the flow FL2, the processor 42 may execute S1 to S5 in FIG. 4, steps S1, S2 and S10 in FIG. 6, or S21, S1, S2, S22 to S25 and S3 to S5 in FIG. 9 on the basis of the temperature TI of the illumination device 38 acquired by the processor 42 serving as the temperature acquisition unit 56.

In the warming-up operation WO of step S5 executed in the flow FL2, the processor 42 executes, for example, the above-described lighting operation LO. The allowable range [Tₜₕ₁, Tₜₕ₂] referred to in the flows FL1 and FL2 may be separately determined for the camera 36 and the illumination device 38 by the method described above.

The flow FL1 for the temperature management of the camera 36 and the flow FL2 for the temperature management of the illumination device 38 are applicable to the flow illustrated in FIG. 4, FIG. 6, or FIG. 9. In this case, after starting the flow of FIG. 4, 6, or 9, the processor 42 executes the flow FL1 for the camera 36 and the flow FL2 for the illumination device 38 in parallel, and thereafter executes steps S6 to S7. Note that the processor 42 may include a first processor 42A configured to execute the flow FL1 and a second processor 42B configured to execute the flow FL2.

In the case where the camera 36 and the illumination device 38 are integrally incorporated in the housing 34, the temperature sensor 16 may include a first temperature sensor 16A configured to measure the temperature Tc of the camera 36 and a second temperature sensor 16B configured to measure the temperature TI of the illumination device 38. In this case as well, the processor 42 may execute the flow FL1 for managing the temperature Tc of the camera 36 and the flow FL2 for managing the temperature TI of the illumination device 38 in parallel.

In this form, the processor 42 may determine YES in step S2 executed in one of the flow FL1 and the flow FL2, and may determine NO in step S2 executed in the other one of the flow FL1 and the flow FL2. In this case, the processor 42 may automatically determine which of the temperature management of the flow FL1 and the temperature management of the flow FL2 is prioritized.

For example, assume that the processor 42 determines YES in step S2 of the flow FL1 and determines NO in step S2 of the flow FL2 when the processor 42 are executing the flows FL1 and FL2 in parallel. In this case, the processor 42 may give priority to the flow FL1 for managing the temperature Tc of the camera 36, and may cancel step S4 (cooling operation CO) and step S5 (warming-up operation WO) to be executed in the flow FL2.

Alternatively, when the processor 42 executes the flows FL1 and FL2 in parallel and then executes steps S6 to S7, the processor 42 may automatically determine which of the temperature management in the flow FL1 and the temperature management in the flow FL2 is prioritized on the basis of the result of the detection operation DO (detection result data RD) in step S6. For example, on the basis of the detection result parameters PRr (the detecting position P, the score α, the contrast β, and the distortion Y) included in the detection result data RD, the processor 42 can determine which of the temperature Tc of the camera 36 and the temperature TI of the illumination device 38 causes the degradation in accuracy of the detection operation DO.

Therefore, the processor 42 may determine which temperature management of the flows FL1 and FL2 is prioritized on the basis of the detection result parameters PRr and execute step S4 (cooling operation CO) and step S5 (warming-up operation WO) of the prioritized flow FL1 or FL2, and may cancel steps S4 and S5 of the non-prioritized flow FL1 or FL2.

In the above-described embodiment, the case where the processor 42 of the controller 18 functions as the apparatuses 100, 110, 120, 130, and 140 has been described. However, the function of the apparatus 100, 110, 120, 130 or 140 may also be implemented in a device different from the controller 18. For example, the function of the apparatus 100 illustrated in FIG. 2 may be implemented in a host controller of the controller 18 or in the imaging unit 14. In this case, a processor of the host controller or the processor 40 of the imaging unit 14 functions as the apparatus 100. In this case, the detection operation executing unit 62 may be omitted from the apparatus 100.

Further, in the embodiment described above, the case where the camera 36 is a two-dimensional camera has been described. However, the camera 36 is not limited thereto and may be a three-dimensional vision sensor. In this case, the image data ID imaged by the camera 36 is, for example, three-dimensional point group image data, and each point appearing in the three-dimensional point group image data includes information on a distance d from the camera 36 to the subject (workpiece W). In this case, a three-dimensional camera coordinate system C3 is set for the camera 36, and each pixel of the image data ID to be imaged is represented by three-dimensional coordinates Qc (xc, yc, zc) in the camera coordinate system C3.

In the embodiment described above, the case where the imaging unit 14 is moved by the robot 12 has been described. However, the present invention is not limited thereto, and the imaging unit 14 may be fixed at the predetermined imaging position IP1. Further, the illumination device 38 may be omitted from the imaging unit 14. The allowable range [Tₜₕ₁, Tₜₕ₂] is not limited to being determined by the various methods mentioned above, and may be determined by any method. Further, the robot 12 is not limited to the vertical articulated robot, and may be, for example, any type of robot such as a horizontal articulated robot or a parallel link robot.

The present disclosure has been described in detail thus far, but the present disclosure is not limited to the individual embodiments. Various additions, replacements, changes, partial deletions, and the like can be made to these embodiments without departing from the gist of the present disclosure or without departing from the gist of the present disclosure derived from the contents described in the claims and equivalents thereof. Further, these embodiments can also be combined with each other and implemented. For example, in the embodiment described above, the order of the operations and the order of the processing are given as an example, and are not limited thereto. The same applies to the case where numerical values or mathematical expressions are used in the description of the above-described embodiment.

With regard to the above-described embodiment, the following supplementary notes are disclosed.

(Supplementary Note 1) The apparatus 100, 110, 120, 130, or 140 configured to manage the temperature T of the imaging unit 14 in the industrial machine 10 which executes the detection operation DO to detect a workpiece W on the basis of the image data ID of the workpiece W imaged by the imaging unit 14 and which carries out work on the detected workpiece W, the apparatus 100, 110, 120, 130 or 140 including: the temperature acquisition unit 56 configured to acquire the temperature T measured by the temperature sensor 16; the temperature determination unit 58 configured to determine whether or not the temperature T, which is acquired by the temperature acquisition unit 56 when the detection operation DO for the work is executed, falls within the allowable range [Tₜₕ₁, Tₜₕ₂] predetermined for securing accuracy of the detection operation DO; and the temperature adjustment unit 60 configured to execute the warming-up operation WO to raise the temperature T when the temperature determination unit 58 determines that the temperature T is lower than the lower limit value Tₜₕ₁ of the allowable range [Tₜₕ₁, Tₜₕ₂], while executing the cooling operation CO to lower the temperature T when the temperature determination unit 58 determines that the temperature T is higher than the upper limit value Tₜₕ₂ of the allowable range [Tₜₕ₁, Tₜₕ₂].

(Supplementary Note 2) The apparatus 110 or 140 of Supplementary Note 1, wherein the temperature acquisition unit 56 is configured to acquire the first temperature T1 or T2 measured by the temperature sensor 16 when the imaging unit 14 executes the imaging operation IO for the teaching process TP for teaching the shape TS of the workpiece W or the calibration process CB for calibrating the imaging parameter PRi of the imaging unit 14, and wherein the apparatus 110 or 140 further includes the allowable range acquisition unit 64 configured to acquire the allowable range [Tₜₕ₁, Tₜₕ₂] determined on the basis of the first temperature T1 or T2, and store the acquired allowable range in the memory 44.

(Supplementary Note 3) The apparatus 120, 130, or 140 of Supplementary Note 1, wherein the temperature adjustment unit 60 is configured to change the temperature T by executing the warming-up operation WO or the cooling operation CO before the work, in order to determine the allowable range [Tₜₕ₁, Tₜₕ₂], and wherein the apparatus 120, 130, or 140 further includes the detection operation executing unit 62 configured to try the detection operation DO when the temperature adjustment unit 60 changes the temperature T.

(Supplementary Note 4) The apparatus 120 or 140 of Supplementary Note 3, further including: the image generating unit 66 configured to generate the detection result image RI displaying results of a plurality of the detection operations DO repeatedly tried by the detection operation executing unit 62; and the input receiving unit 68 configured to receive an input of the lower limit value Tₜₕ₁ and the upper limit value Tₜₕ₂ determined on the basis of the results of the detection operations DO.

(Supplementary Note 5) The apparatus 130 or 140 of Supplementary Note 3, further including the allowable range determination unit 82 configured to automatically determine the lower limit value Tₜₕ₁ or the upper limit value Tₜₕ₂ of the allowable range [Tₜₕ₁, Tₜₕ₂], on the basis of results of a plurality of the detection operations DO repeatedly tried by the detection operation executing unit 62

(Supplementary Note 6) The apparatus 130 or 140 of Supplementary Note 5, wherein the detection operation executing unit 62 is configured to repeatedly try the detection operation DO every time the temperature adjustment unit 60 changes the temperature T by the predetermined change amount δT, and
wherein the allowable range determination unit 82 is configured to:
determine whether or not a detection result parameter PRr included in the result of the detection operation DO falls within a threshold value range capable of securing the accuracy, every time the detection operation executing unit 62 tries the detection operation DO; and
determine the lower limit value Tₜₕ₁ or the upper limit value Tₜₕ₂ on the basis of the determination result of the detection result parameter PRr.

(Supplementary Note 7) The apparatus 100, 110, 120, 130, or 140 of any one of Supplementary Notes 1 to 6, wherein the temperature adjustment unit 60 is configured to raise the temperature T by causing the imaging unit 14 to simulatively execute the imaging operation IO, causing the processor 40 incorporated in the imaging unit 14 to execute the predetermined arithmetic processing CL, or turning on the illumination device 38 provided in the imaging unit 14, as the warming-up operation WO.

(Supplementary Note 8) The apparatus 100, 110, 120, 130, or 140 of any one of Supplementary Notes 1 to 7, wherein the temperature adjustment unit 60 is configured to lower the temperature T by stopping an operation of the imaging unit 14 for the predetermined cooling time tₜₕ₁, as the cooling operation CO.

(Supplementary Note 9) The apparatus 100, 110, 120, 130, or 140 of any one of Supplementary Notes 1 to 8, wherein the temperature determination unit 58 is configured to determine whether or not the temperature T falls within the allowable range [Tₜₕ₁, Tₜₕ₂] every time the temperature adjustment unit 60 executes the warming-up operation WO or the cooling operation CO, and wherein the apparatus 100, 110, 120, 130, or 140 further includes the detection operation executing unit 62 configured to execute the detection operation DO for the work when the temperature determination unit 58 determines that the temperature T falls within the allowable range [Tₜₕ₁, Tₜₕ₂], while not executing the detection operation DO while the temperature determination unit 58 determines that the temperature T is outside the allowable range [Tₜₕ₁, Tₜₕ₂].

(Supplementary Note 10) The apparatus 100, 110, 120, 130, or 140 of Supplementary Note 9, wherein the detection operation executing unit 62 is configured to execute the detection operation DO for the work when the elapsed time t3, which is clocked while the temperature determination unit 58 determines that the temperature T is outside the allowable range [Tₜₕ₁, Tₜₕ₂], reaches the predetermined time limit tₜₕ₃.

(Supplementary Note 11) The apparatus 140 of any one of Supplementary Notes 1 to 10,
wherein the temperature adjustment unit 60 is configured to execute the warming-up operation WO when the imaging unit 14 is activated,
wherein the apparatus 140 further includes:
the detection operation executing unit 62 configured to repeatedly try the detection operation DO every time the temperature adjustment unit 60 executes the warming-up operation WO;
the difference acquisition unit 84 configured to acquire a difference δrᵢ between a detection result parameter PRrᵢ included in a result of a first detection operation DOᵢ tried by the detection operation executing unit 62 and a detection result parameter PRrᵢ₋₁ included in a result of a second detection operation DOᵢ₋₁ tried by the detection operation executing unit 62 before the first detection operation DOᵢ; and
the difference determination unit 86 configured to determine whether or not the difference δrᵢ acquired by the difference acquisition unit 84 is smaller than the predetermined threshold value Orth, and
wherein the detection operation executing unit 62 executes the detection operation DO for the work when the difference determination unit 86 determines that the difference δrᵢ is smaller than the threshold value Orth.

(Supplementary Note 12) The apparatus 140 of any one of Supplementary Notes 1 to 10,
wherein the temperature adjustment unit 60 is configured to execute the warming-up operation WO when the imaging unit 14 is activated,
wherein the temperature acquisition unit 56 is configured to acquire the temperature T repeatedly measured by the temperature sensor 16 every time the temperature adjustment unit 60 executes the warming-up operation WO, and
wherein the apparatus 140 further includes:
the difference acquisition unit 84 configured to acquire a difference δMᵢ between a first temperature Tᵢ acquired by the temperature acquisition unit 56 and a second temperature Tᵢ₋₁ acquired by the temperature acquisition unit 56 before the first temperature Tᵢ;
the difference determination unit 86 configured to determine whether or not the difference δMᵢ acquired by the difference acquisition unit 84 is smaller than the predetermined threshold value δMₜₕ; and
the detection operation executing unit 62 configured to execute the detection operation DO for the work when the difference determination unit 86 determines that the difference δMᵢ is smaller than the threshold value δMₜₕ.

(Supplementary Note 13) The controller 18 of the industrial machine 10, including the apparatus 100, 110, 120, 130, or 140 of any one of Supplementary Notes 1 to 12.

(Supplementary Note 14) A method of managing the temperature T of the imaging unit 14 in the industrial machine 10 which executes the detection operation DO to detect a workpiece W on the basis of the image data ID of the workpiece W imaged by the imaging unit 14 and which carries out work on the detected workpiece W, the method including:
acquiring, by a processor, the temperature T measured by the temperature sensor 16;
determining, by the processor, whether or not the temperature T, which is acquired when the detection operation DO for the work is executed, falls within the allowable range [Tₜₕ₁, Tₜₕ₂] predetermined for securing accuracy of the detection operation DO; and
executing, by the processor, the warming-up operation WO to raise the temperature T when it is determined that the temperature T is lower than the lower limit value Tₜₕ₁ of the allowable range [Tₜₕ₁, Tₜₕ₂], while executing the cooling operation CO to lower the temperature T when it is determined that the temperature T is higher than the upper limit value Tₜₕ₂ of the allowable range [Tₜₕ₁, Tₜₕ₂].

(Supplementary Note 15) The computer program PG configured to cause the processor 42 to execute the method of Supplementary Note 14.

### REFERENCE SIGNS LIST

10 Industrial machine
12 Robot
14 Imaging unit
16 Temperature sensor
18 Controller
36 Camera
38 Illumination device
40, 42 Processor
56 Temperature acquisition unit
58 Temperature determination unit
60 Temperature adjustment unit
62 Detection operation executing unit
64 Allowable range acquisition unit
66 Image generating unit
68 Input receiving unit
82 Allowable range determination unit
84 Difference acquisition unit
86 Difference determination unit
100, 110, 120, 130, 140 Apparatus

1. An apparatus configured to manage a temperature of an imaging unit in an industrial machine which executes a detection operation to detect a workpiece on the basis of image data of the workpiece imaged by the imaging unit and which carries out work on the detected workpiece, the apparatus comprising:
a temperature acquisition unit configured to acquire the temperature measured by a temperature sensor;
a temperature determination unit configured to determine whether or not the temperature, which is acquired by the temperature acquisition unit when the detection operation for the work is executed, falls within an allowable range predetermined for securing accuracy of the detection operation; and
a temperature adjustment unit configured to execute a warming-up operation to raise the temperature when the temperature determination unit determines that the temperature is lower than a lower limit value of the allowable range, while executing a cooling operation to lower the temperature when the temperature determination unit determines that the temperature is higher than an upper limit value of the allowable range.

2. The apparatus of claim 1, wherein the temperature acquisition unit is configured to acquire a first temperature measured by the temperature sensor when the imaging unit executes an imaging operation for a teaching process for teaching a shape of the workpiece or a calibration process for calibrating an imaging parameter of the imaging unit, and
wherein the apparatus further includes an allowable range acquisition unit configured to acquire the allowable range determined on the basis of the first temperature, and store the acquired allowable range in a memory.

3. The apparatus of claim 1, wherein the temperature adjustment unit is configured to change the temperature by executing the warming-up operation or the cooling operation before the work, in order to determine the allowable range, and
wherein the apparatus further includes a detection operation executing unit configured to try the detection operation when the temperature adjustment unit changes the temperature.

4. The apparatus of claim 3, further comprising:
an image generating unit configured to generate a detection result image displaying results of a plurality of the detection operations repeatedly tried by the detection operation executing unit; and
an input receiving unit configured to receive an input of the lower limit value and the upper limit value determined on the basis of the results of the detection operations.

5. The apparatus of claim 3, further comprising an allowable range determination unit configured to automatically determine the lower limit value or the upper limit value of the allowable range, on the basis of results of a plurality of the detection operations repeatedly tried by the detection operation executing unit.

6. The apparatus of claim 5, wherein the detection operation executing unit is configured to repeatedly try the detection operation every time the temperature adjustment unit changes the temperature by a predetermined change amount, and
wherein the allowable range determination unit is configured to:
determine whether or not a detection result parameter included in the result of the detection operation falls within a threshold value range capable of securing the accuracy, every time the detection operation executing unit tries the detection operation; and
determine the lower limit value or the upper limit value on the basis of the determination result of the detection result parameter.

7. The apparatus of claim 1, wherein the temperature adjustment unit is configured to raise the temperature by causing the imaging unit to simulatively execute an imaging operation, causing a processor incorporated in the imaging unit to execute predetermined arithmetic processing, or turning on an illumination device provided in the imaging unit, as the warming-up operation.

8. The apparatus of claim 1, wherein the temperature adjustment unit is configured to lower the temperature by stopping an operation of the imaging unit for a predetermined cooling time, as the cooling operation.

9. The apparatus of claim 1, wherein the temperature determination unit is configured to determine whether or not the temperature falls within the allowable range, every time the temperature adjustment unit executes the warming-up operation or the cooling operation, and
wherein the apparatus further comprises a detection operation executing unit configured to execute the detection operation for the work when the temperature determination unit determines that the temperature falls within the allowable range, while not executing the detection operation while the temperature determination unit determines that the temperature is outside the allowable range.

10. The apparatus of claim 9, wherein the detection operation executing unit is configured to execute the detection operation for the work when an elapsed time, which is clocked while the temperature determination unit determines that the temperature is outside the allowable range, reaches a predetermined time limit.

11. The apparatus of claim 1, wherein the temperature adjustment unit is configured to execute the warming-up operation when the imaging unit is activated,
wherein the apparatus further comprises:
a detection operation executing unit configured to repeatedly try the detection operation every time the temperature adjustment unit executes the warming-up operation;
a difference acquisition unit configured to acquire a difference between a detection result parameter included in a result of a first detection operation tried by the detection operation executing unit and a detection result parameter included in a result of a second detection operation tried by the detection operation executing unit before the first detection operation; and
a difference determination unit configured to determine whether or not the difference acquired by the difference acquisition unit is smaller than a predetermined threshold value, and
wherein the detection operation executing unit is configured to execute the detection operation for the work when the difference determination unit determines that the difference is smaller than the threshold value.

12. The apparatus of claim 1, wherein the temperature adjustment unit is configured to execute the warming-up operation when the imaging unit is activated,
wherein the temperature acquisition unit is configured to acquire the temperature repeatedly measured by the temperature sensor every time the temperature adjustment unit executes the warming-up operation, and
wherein the apparatus further includes:
a difference acquisition unit configured to acquire a difference between a first temperature acquired by the temperature acquisition unit and a second temperature acquired by the temperature acquisition unit before the first temperature;
a difference determination unit configured to determine whether or not the difference acquired by the difference acquisition unit is smaller than a predetermined threshold value; and
a detection operation executing unit configured to execute the detection operation for the work when the difference determination unit determines that the difference is smaller than the threshold value.

13. A controller of the industrial machine, comprising the apparatus of claim 1.

14. A method of managing a temperature of an imaging unit in an industrial machine which executes a detection operation to detect a workpiece on the basis of image data of the workpiece imaged by the imaging unit and which carries out work on the detected workpiece,
the method comprising:
acquiring, by a processor, the temperature measured by a temperature sensor;
determining, by the processor, whether or not the temperature, which is acquired when the detection operation for the work is executed, falls within an allowable range predetermined for securing accuracy of the detection operation; and
executing, by the processor, a warming-up operation to raise the temperature when it is determined that the temperature is lower than a lower limit value of the allowable range, while executing a cooling operation to lower the temperature when it is determined that the temperature is higher than an upper limit value of the allowable range.

15. A non-transitory computer-readable recording medium which stores a computer program configured to cause the processor to execute the method of claim 14.
